(19) United States
(12) Patent Application Publication
(10) Pub. No.: US 2025/0092735 A1
(43) Pub. Date: Mar. 20, 2025

(54) BUILDING MATERIAL COUPLING DEVICE, COUPLING STRUCTURE THEREOF, AND COUPLING METHOD THEREOF

(71) Applicant: BUNKA SHUTTER CO., LTD., Tokyo (JP)

(72) Inventor: Shigeo YAMAGAMI, Tokyo (JP)

(21) Appl. No.: 18/699,212

(22) PCT Filed: Oct. 8, 2021
(86) PCT No.: PCT/JP2021/037337

§ 371 Date: Nov. 7, 2024

(51) Int. Cl. E06B 1/60

(52) U.S. Cl. CPC E06B 1/6038; E06B 1/6092

(57) ABSTRACT

Two building materials are coupled by a plurality of couplers (10A). Each coupler includes a foundation member (20) arranged on one building material (2), and a coupling member (21) extending from the foundation member to the side of the other building material and joined to the other building material by a joint. The foundation member is provided with a guide portion formed by an outer edge portion (20A, 20B) configured to guide the coupling member movably in a direction having a component in a thickness direction of the one building material. At least two couplers are provided on the one building material in a direction orthogonal to a direction of the interval and the thickness direction of the one building material. The guide portions of the foundation members of the couplers have different tilting directions or tilting angles with respect to the direction orthogonal to the direction of the interval and the thickness direction of the one building material. It is therefore possible to implement, by couplers having a simple structure, positioning one building material in the thickness direction of the one building material and coupling two building materials by a plurality of couplers.

### TECHNICAL FIELD

The present invention relates to a building material coupling device for coupling two building materials arranged at an interval, a coupling structure thereof, and a coupling method thereof and, for example, when arranging an opening frame such as a door frame that is a device side building material of a hinged door device or a sliding door device in an opening portion of a wall, there can be used to couple the opening frame and a wall side building material.

### BACKGROUND ART

Patent literature 1 below shows a coupling device for coupling an opening frame such as a door frame and a wall side building material, which are two building materials arranged at an interval. The coupling device couples two building materials by a plurality of couplers. Each of these couplers comprises a foundation member arranged on one building material of the two building materials and having a center axis whose axial direction is the thickness direction of the one building material, and a coupling member having a length extending from the foundation member to the side of the other building material and joined to the other building material by a joint. As for the two end portions of the coupling member of each coupler, a hole through which the foundation member is inserted is formed at the end portion on the side of the one building material, and a torsion angle that is a tilting angle with respect to the axial direction of the foundation member is provided at the end portion on the side of the other building material. If the end portion on the side of the other building material is joined to the other building material by a joint, a torsion angle with respect to the axial direction of the foundation member is generated at the end portion on the side of the one building material due to the decrease or disappearance of the torsion angle. Accordingly, the end portion on the side of the one building material is locked. For this reason, the coupling member is immobilized in the thickness direction of the one building material, the one building material is positioned in the thickness direction of the one building material, and the two building materials are coupled by a plurality of couplers.

### Related Art Literature

### Patent Literature

Patent Literature 1: Japanese Patent Laid-Open No. 2020-Disclosure of Invention

### Problem to be Solved by the Invention

A device for positioning one building material in the thickness direction of the one building material and coupling two building materials by a plurality of couplers is required to reduce cost, and to do this, the structure of the coupler is demanded to be simplified.

It is an object of the present invention to provide a building material coupling device capable of implementing positioning one building material in the thickness direction of the one building material and coupling two building materials by a plurality of couplers while simplifying the structure of the coupler, a coupling structure thereof, and a coupling method thereof.

### Means of Solution to the Problem

According to the present invention, there is provided a building material coupling device for coupling two building materials arranged at an interval by a plurality of couplers, each coupler including a foundation member arranged on one building material of the two building materials, and a coupling member having a length extending from the foundation member to a side of the other building material and joined to the other building material by a joint, wherein the foundation member of each coupler is provided with a guide portion configured to guide the coupling member movably in a direction having a component in a thickness direction of the one building material, at least two couplers are provided on the one building material in a direction orthogonal to a direction of the interval and the thickness direction of the one building material, the guide portions of the foundation members of the couplers have different tilting directions or tilting angles with respect to the direction orthogonal to the direction of the interval and the thickness direction of the one building material, before the coupling member arranged for the foundation member of each coupler is joined to the other building material by the joint, each coupling member is guided by the guide portion to be movable, and since each coupling member is joined to the other building material by the joint, each coupling member cannot be guided by the guide portion and moved.

As described above, the foundation member of the coupler in the building material coupling device according to the present invention is provided with the guide portion configured to guide the coupling member movably in the direction having the component in the thickness direction of the one building material. Also, at least two couplers are provided on the one building material in the direction orthogonal to the direction of the interval between the two building materials and the thickness direction of the one building material. The guide portions of the foundation members of the couplers have different tilting directions or tilting angles with respect to the direction orthogonal to the direction of the interval between the two building materials and the thickness direction of the one building material. For this reason, before the coupling member arranged for the foundation member of each coupler is joined to the other building material by the joint, each coupling member is guided by the guide portion to be movable. If the arrangement position of the coupling member on the foundation member is adjusted in the thickness direction of the one building material by causing the guide portion to guide and move each coupling member, and after that, each coupling member is joined to the other building material by the joint, each coupling member is immobilized in the thickness direction of the one building material.

Hence, by the above-described work of adjusting the arrangement position of each coupling member in the thickness direction of the one building material, the one building material can be positioned in the thickness direction of the one building material, and the two building materials can be coupled by the plurality of couplers.

Since positioning the one building material in the thickness direction of the one building material and coupling the two building materials by the plurality of couplers can be implemented only by causing the guide portions of the foundation members of the at least two couplers provided on the one building material to have different tilting directions or tilting angles with respect to the direction orthogonal to the direction of the interval between the two building materials and the thickness direction of the one building material, the structure of the coupler including the foundation member and the coupling member as constituent members can be simplified.

Note that causing the guide portions of the foundation members of the at least two couplers provided on the one building material to have different tilting directions or tilting angles with respect to the direction orthogonal to the direction of the interval between the two building materials and the thickness direction of the one building material may be implemented by forming the foundation members into the same shape and same size and thus, when arranging the foundation members on the one building material, causing the guide portions provided on the foundation members to have different tilting directions or tilting angles with respect to the direction orthogonal to the direction of the interval between the two building materials and the thickness direction of the one building material, or by forming the foundation members into different shapes or sizes and thus, when arranging the foundation members on the one building material, causing the guide portions provided on the foundation members to have different tilting directions or tilting angles with respect to the direction orthogonal to the direction of the interval between the two building materials and the thickness direction of the one building material.

According to the former of these, since the foundation members can have the same shape and same size, the structure of the coupler can be simplified even in terms of using foundation members with common structures. Note that the foundation members having the same shape and same size here includes a case where the manufactured foundation members include differences of shape or size due to processing errors.

Also, in the building material coupling device according to the present invention described above, the form that the guide portion is provided on the coupler is arbitrary. As an example of the guide portion, if an outer edge portion extending in the direction including the component in the thickness direction of the one building material is provided on the foundation member, the outer edge portion is used as the guide portion.

In a case where the outer edge portion of the foundation member is used as the guide portion, if the foundation member includes two outer edge portions parallel to each other, these outer edge portions may be used as the guide portion.

As another example of the guide portion, a long hole that is long in the direction having the component in the thickness direction of the one building material is formed in the foundation member, and an internal long side portion of the long hole is used as the guide portion.

If the long hole formed in the foundation member includes two internal long side portions parallel to each other, the internal long side portions may be used as the guide portion.

Furthermore, the guide portion provided on the foundation member may be a flat plate-shaped portion whose thickness is constant in a direction in which the coupling member can move. According to this, the coupling member can smoothly be moved by the flat plate-shaped portion.

If the guide portion provided on the foundation member is the flat plate-shaped portion whose thickness is constant in the direction in which the coupling member can move, as described above, it is preferable that the coupling member is provided with a detachment preventing portion that is connected to the main body of the coupling member and faces the foundation member on the back side of the foundation member, and the guide portion of the foundation member, which movably guides the coupling member, is inserted between the detachment preventing portion and the main body of the coupling member. According to this, it is possible to cause the guide portion to guide and move the coupling member while the detachment preventing portion prevents the coupling member from being detached from the guide portion.

Providing the detachment preventing portion on the coupling member can be implemented by various kinds of modes. An example, the main body of the coupling member is provided with a straddling portion that straddles an outer side of the guide portion, and the detachment preventing portion projecting in the direction orthogonal to the direction of the interval between the two building materials and the thickness direction of the one building material is provided at an end portion of the straddling portion on an opposite side of the main body of the coupling member. According to this, it is possible to more reliably prevent the coupling member from being detached from the guide portion by both the outer edge portion and the straddling portion.

Also, in a case where the coupling member is provided with the above-described detachment preventing portion, if the widthwise direction of the coupling member is the direction orthogonal to the direction of the interval between the two building materials and the thickness direction of the one building material, it is preferable that the detachment preventing portions are provided on both sides of the coupling member in the widthwise direction, and the detachment preventing portions are provided at the same position in the direction orthogonal to the direction of the interval between the two building materials and the thickness direction of the one building material.

According to this, as described above, even if the foundation members are arranged on the one building material while causing the guide portions of the foundation members of the at least two couplers provided on the one building material to have different tilting directions or tilting angles with respect to the direction orthogonal to the direction of the interval between the two building materials and the thickness direction of the one building material, the coupling members of the at least two couplers provided on the one building material can have a common structure.

According to the present invention, there is provided a building material coupling structure for coupling two building materials arranged at an interval by a plurality of couplers, each coupler including a foundation member arranged on one building material of the two building materials, and a coupling member having a length extending from the foundation member to a side of the other building material and joined to the other building material by a joint, wherein at least two couplers are provided on the one building material in a direction orthogonal to a direction of the interval and a thickness direction of the one building material, the foundation member of each coupler is provided with a guide portion configured to guide the coupling member movably in a direction having a component in the thickness direction of the one building material, the foundation members of the at least two couplers are arranged on the one building material while the guide portions of the foundation members of the at least two couplers have different tilting directions or tilting angles with respect to the direction orthogonal to the direction of the interval and the thickness direction of the one building material, before the coupling member arranged for each foundation member is joined to the other building material by the joint, each coupling member is guided by the guide portion to be movable, and since each coupling member is joined to the other building material by the joint, each coupling member cannot be guided by the guide portion and moved.

In this building material coupling structure as well, at least two couplers are provided on the one building material in the direction orthogonal to the direction of the interval between the two building materials and the thickness direction of the one building material. The foundation member of the coupler is provided with the guide portion configured to guide the coupling member movably in the direction having the component in the thickness direction of the one building material. The guide portions have different tilting directions or tilting angles with respect to the direction orthogonal to the direction of the interval between the two building materials and the thickness direction of the one building material, and the foundation members of the at least two couplers are arranged on the one building material. Before the coupling member arranged for the foundation member of each coupler is joined to the other building material by the joint, the arrangement position of the coupling member on the foundation member can be adjusted in the thickness direction of the one building material by causing the guide portion to guide and move each coupling member. After that, when each coupling member is joined to the other building material by the joint, each coupling member is immobilized in the thickness direction of the one building material. Hence, by the above-described work of adjusting the arrangement position of each coupling member in the thickness direction of the one building material, the one building material can be positioned in the thickness direction of the one building material, and the two building materials can be coupled by the plurality of couplers.

To position the one building material in the thickness direction of the one building material and couple the two building materials by the plurality of couplers, the foundation members of the at least two couplers are arranged on the one building material by causing the guide portions of the foundation members of the at least two couplers provided on the one building material to have different tilting directions or tilting angles with respect to the direction orthogonal to the direction of the interval between the two building materials and the thickness direction of the one building material. Hence, the structure of the coupler including the foundation member and the coupling member as constituent members can be simplified.

Note that in the building material coupling structure as well, in the direction orthogonal to the direction of the interval between the two building materials and the thickness direction of the one building material, causing the guide portions of the foundation members of the at least two couplers provided on the one building material to have different tilting directions or tilting angles with respect to the direction orthogonal to the direction of the interval between the two building materials and the thickness direction of the one building material may be forming the foundation members into the same shape and same size and thus, when arranging the foundation members on the one building material, causing the guide portions of the foundation members to have different tilting directions or tilting angles with respect to the direction orthogonal to the direction of the interval between the two building materials and the thickness direction of the one building material, or forming the foundation members into different shapes or sizes and thus, when arranging the foundation members on the one building material, causing the guide portions of the foundation members to have different tilting directions or tilting angles with respect to the direction orthogonal to the direction of the interval between the two building materials and the thickness direction of the one building material.

According to the present invention, there is provided a building material coupling method for coupling two building materials arranged at an interval by a plurality of couplers, each coupler including a foundation member arranged on one building material of the two building materials, and a coupling member having a length extending from the foundation member to a side of the other building material and joined to the other building material by a joint, the method comprising a first work step of arranging the foundation members of at least two couplers on the one building material in a direction orthogonal to a direction of the interval and a thickness direction of the one building material, performing an arrangement work for the foundation members to the one building material while causing guide portions provided on the foundation members to guide the coupling members movably in a direction having a component in the thickness direction of the one building material to have different tilting directions or tilting angles with respect to the direction orthogonal to the direction of the interval and the thickness direction of the one building material, and causing the guide portion to guide and movably arrange the coupling member for each foundation member, a second work step of adjusting an arrangement position of the coupling member on the foundation member in the direction having the component in the thickness direction of the one building material by causing the guide portion to guide and move each coupling member, and a third work step of joining each coupling member to the other building material by the joint.

Hence, in this building material coupling method, first, the work of arranging the foundation members of the at least two couplers on the one building material in the direction orthogonal to the direction of the interval and the thickness direction of the one building material is performed. This work is performed while causing guide portions provided on the foundation members to guide the coupling members movably in the direction having the component in the thickness direction of the one building material to have different tilting directions or tilting angles with respect to the direction orthogonal to the direction of the interval and the thickness direction of the one building material. The work of causing the guide portion to guide and movably arrange the coupling member for each foundation member is also performed. Next, the work of adjusting the arrangement position of the coupling member on the foundation member in the direction having the component in the thickness direction of the one building material by causing the guide portion to guide and move each coupling member is performed. After that, the work of joining each coupling member to the other building material by the joint is performed. Hence, by the above-described work of adjusting the arrangement position of each coupling member in the thickness direction of the one building material, if each coupling member is joined to the other building material by the joint, the one building material can be positioned in the thickness direction of the one building material, and the two building materials can be coupled by the plurality of couplers.

To position the one building material in the thickness direction of the one building material and couple the two building materials by the plurality of couplers, at least two couplers are provided on the one building material the direction orthogonal to the direction of the interval between the two building materials and the thickness direction of the one building material, and the guide portions of the foundation members of the couplers to have different tilting directions or tilting angles with respect to the direction orthogonal to the direction of the interval between the two building materials and the thickness direction of the one building material. Hence, the structure of the coupler including the foundation member and the coupling member as constituent members can be simplified.

Note that in the first work step of the building material coupling method according to the present invention described above, in the direction orthogonal to the direction of the interval between the two building materials and the thickness direction of the one building material, causing the guide portions of the foundation members of the at least two couplers to have different tilting directions or tilting angles with respect to the direction orthogonal to the direction of the interval between the two building materials and the thickness direction of the one building material may be forming the foundation members into the same shape and same size and thus, when arranging the foundation members on the one building material, causing the guide portions of the foundation members to have different tilting directions or tilting angles with respect to the direction orthogonal to the direction of the interval between the two building materials and the thickness direction of the one building material, or forming the foundation members into different shapes or sizes and thus, when arranging the foundation members on the one building material, causing the guide portions of the foundation members to have different tilting directions or tilting angles with respect to the direction orthogonal to the direction of the interval between the two building materials and the thickness direction of the one building material.

The coupling member of the coupler used in the building material coupling device, the coupling structure, and the coupling method according to the present invention described above can have an arbitrary shape and structure. For example, the whole or the substantially whole of the coupling member may be formed into a plate shape. Alternatively, the whole or the substantially whole of the coupling member may be formed such that it has an L-shaped cross section or a U-shaped cross section including, for example, a portion having a component in the thickness direction of the one building material and a portion having a component in the direction orthogonal to the direction of the interval between the two building materials and the thickness direction of the one building material.

Also, the two building materials to be coupled by the building material coupling device, the coupling structure, and the coupling method according to the present invention described above can be arbitrary building materials. As an example, the building materials are a building material on a wall side and an opening frame arranged facing the building material in the left-right direction or upward-downward direction. The opening frame may be, for example, a door frame for a hinged door device, an opening frame for a sliding door device, an opening frame for an opening portion for passage formed in a wall, a fixed opening frame in which a member arranged inside is fixed, or a sash frame for a window. One of the two building materials may be a door pocket used to store a fire door that is normally opened from a door frame. In addition, the building material coupler, the coupling structure, and the coupling method according to the present invention can also be used to couple two building materials such as columns including an intermediate column of a building, beams, horizontal sash bars, or face materials, and applied building materials are arbitrary.

The building material coupling device, the coupling structure, and the coupling method according to the present invention can be applied to a building material to be newly installed in a structure such as a building and can also be applied to a building material to be repaired.

### Effect of the Invention

According to the present invention, it is possible to obtain an effect of implementing positioning one building material in the thickness direction of the one building material and coupling two building materials by a plurality of couplers while simplifying the structure of the coupler.

### BRIEF DESCRIPTION OF DRAWINGS

FIG. 1 is an overall front view showing a hinged door device to which a building material coupler according to an embodiment of the present invention is applied;

FIG. 2 is an overall front view showing a door frame that is a building material on the hinged door device side;

FIG. 3 is an overall front view showing a structure in which the door frame and reinforcing members that are building materials on a wall side are coupled by first couplers and second couplers of a coupling device via auxiliary members attached to the reinforcing members;

FIG. 4 is a plan sectional view that is a sectional view taken along a line S4-S4 in FIG. 3 and shows a coupling structure by the first coupler;

FIG. 5 is a front view of FIG. 4 that shows the coupling structure by the first coupler;

FIG. 6 is a view showing a coupling structure by the second coupler, like FIG. 5;

FIG. 7 shows the door frame to which the foundation members of the couplers are attached, in which (A) is a plan view, (B) is a left side view, (C) is a front view, and (D) is a right side view;

FIG. 8 shows the door frame in a state in which the coupling member of the coupler is arranged in the foundation member of the coupler, in which (A) is a plan view, (B) is a left side view, (C) is a front view, and (D) is a right side view;

FIG. 9 is a partial enlarged view of FIG. 8 that shows the first coupler;

FIG. 10 shows the coupling member of the first coupler, in which (A) is a side view, and (B) is a front view;

FIG. 11 is a perspective view showing the coupling member of the first coupler;

FIG. 12 is a perspective view of FIG. 9;

FIG. 13 is a partial enlarged view of FIG. 8 that shows the second coupler;

FIG. 14 is a perspective view showing the coupling member of the second coupler;

FIG. 15 is a view showing a state immediately before the coupling member of the first coupler is bent, like FIG. 12;

FIG. 16 is a view showing a state immediately after the coupling member of the first coupler is bent, like FIG. 5;

FIG. 17 is a view showing a work of joining the distal end portion of the bent coupling member of the first coupler to a reinforcing member that is a building material on the wall side by a joint via an auxiliary member, like FIG. 5;

FIG. 18 is a view showing the second coupler, like FIG. 12;

FIG. 19 is a view showing the second coupler, like FIG. 15;

FIG. 20 is a view showing the second coupler, like FIG. 16;

FIG. 21 is a view showing the second coupler, like FIG. 17;

FIG. 22 is a view showing a first coupler according to another embodiment, like FIG. 9;

FIG. 23 shows the coupling member of the first coupler according to another embodiment shown in FIG. 22, in which (A) is a side view, and (B) is a front view; and

FIG. 24 is a perspective view showing the coupling member of the first coupler according to another embodiment shown in FIG. 22.

### BEST MODE FOR CARRYING OUT THE INVENTION

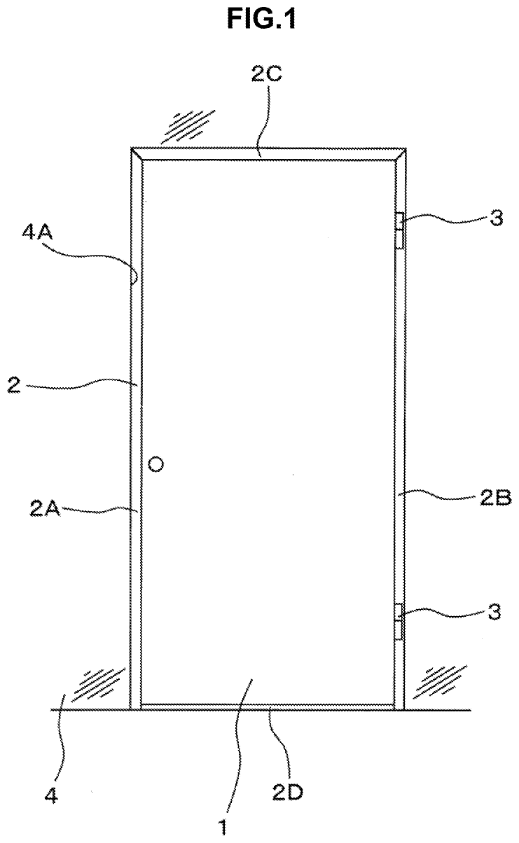

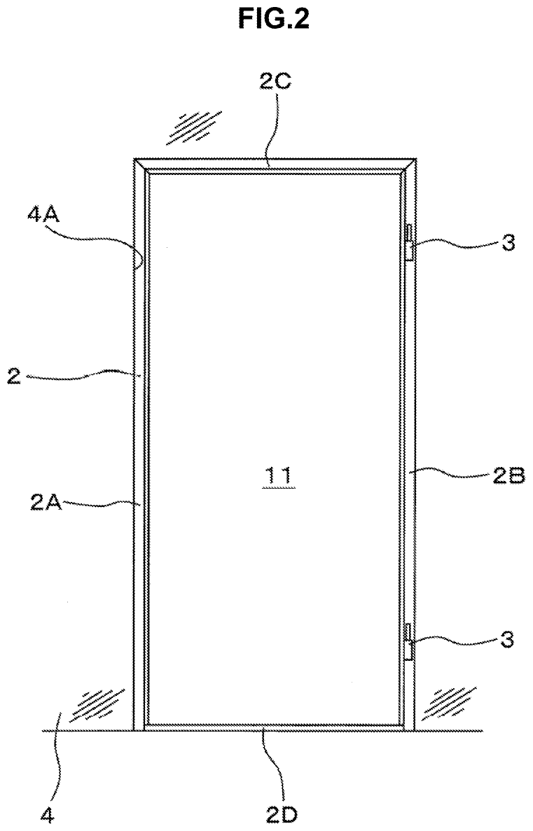

A mode for carrying out the present invention will now be described with reference to the accompanying drawings. FIG. 1 is an overall front view of a hinged door device. The hinged door device is formed by attaching a hinged door 1 to a door frame 2 such that the hinged door 1 can pivot about hinges 3. The door frame 2 is arranged inside an opening portion 4A formed in a wall 4 of a building. FIG. 2 shows the door frame 2 before the hinged door 1 is attached. As shown in FIG. 2, the door frame 2 is an opening frame whose inside serves as an entrance 11 to be opened/closed by the hinged door 1. The door frame 2 according to this embodiment is a four-side frame, and is therefore formed by left and right side frame members 2A and 2B, an upper frame member 2C, and a lower frame member 2D that is a door sill member. These frame members 2A, 2B, 2C, and 2D are welded and joined in a factory in advance and conveyed to the construction site of a construct such as a building in which the opening device is installed and constructed.

Note that the door frame 2 may be a three-side frame without the lower frame member 2D.

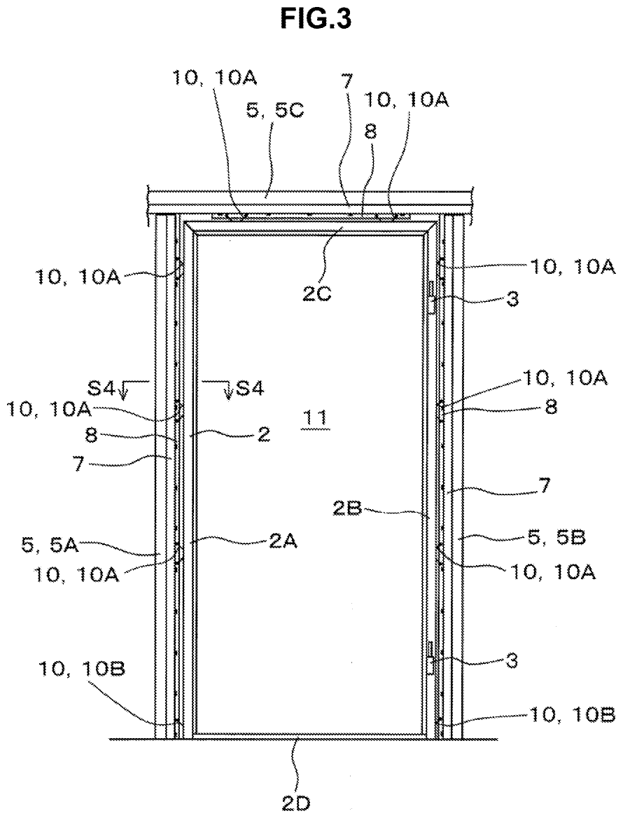

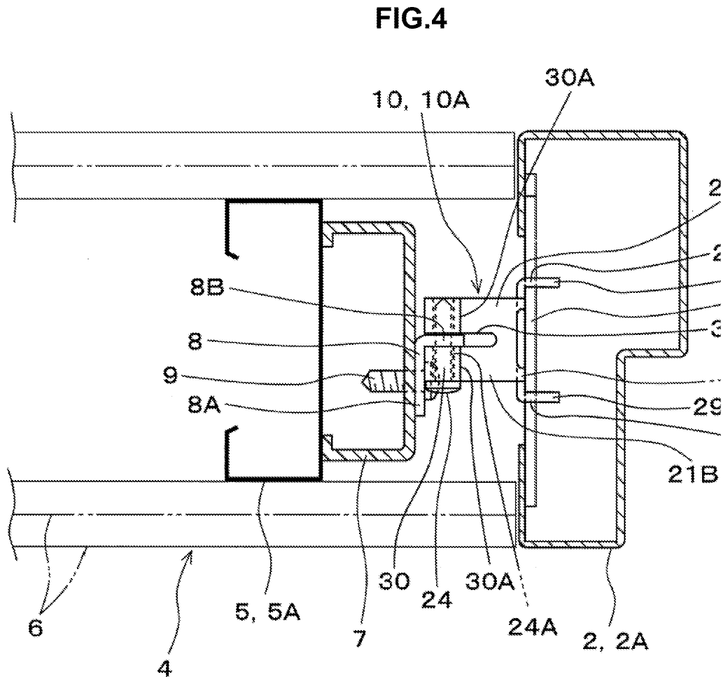

FIG. 3 shows the arrangement state of the door frame 2 in the wall 4 shown in FIGS. 1 and 2. FIG. 4 is a sectional view taken along a line S4-S4 in FIG. 3. The wall 4 shown in FIGS. 1 and 2 is formed by fixing face materials 6 such as plasterboards to both the obverse and reverse surfaces of core members 5, as shown in FIG. 4. The door frame 2 is arranged inside the opening portion 4A shown in FIGS. 1 and 2, which is provided in the wall 4. FIG. 3 shows, of many core members 5 provided inside the wall 4, core members 5A and 5B arranged at portions facing the left and right side frame members 2A and 2B of the door frame 2 in the left-right direction while setting their longitudinal direction in the vertical direction, and a core member 5C arranged at a portion facing the upper frame member 2C of the door frame 2 in the upward-downward direction while setting its longitudinal direction in the left-right direction.

Before a work of arranging the door frame 2 inside the opening portion 4A of the wall 4 is performed, a reinforcing member 7 shown in FIGS. 3 and 4 is joined to each of the core members 5A, 5B, and 5C in advance, and an auxiliary member 8 is attached to each reinforcing member 7 by a joint 9 shown in FIG. 4. The auxiliary member 8 is formed by an angle material in which two projecting piece portions 8A and 8B that are plate-shaped portions make a right angle. Of the projecting piece portions 8A and 8B, one projecting piece portion 8A is joined to the reinforcing member 7 by the joint 9, and the other projecting piece portion 8B projects to the side of the door frame 2.

In the above-described structure, since the core members 5, the reinforcing members 7, and the auxiliary members 8 are members on the side of the wall 4, the core members 5, the reinforcing members 7, and the auxiliary members 8 are wall side building materials. On the other hand, since the hinged door 1 and the door frame 2 are members on the side of the hinged door device installed in the wall 4, the hinged door 1 and the door frame 2 are hinged door device side building materials.

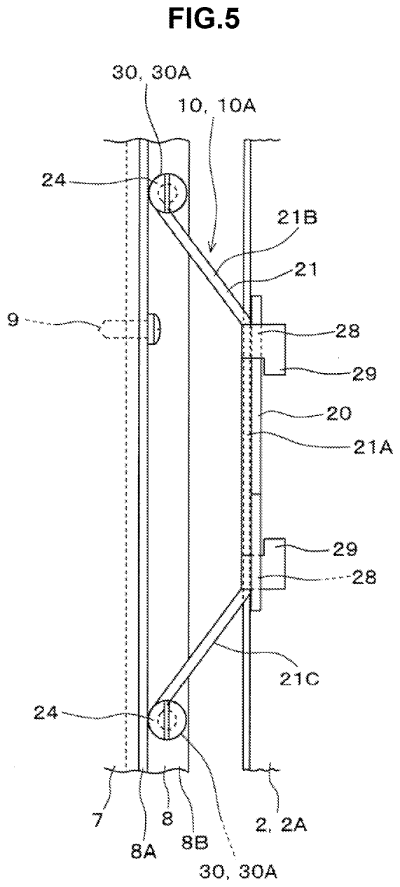

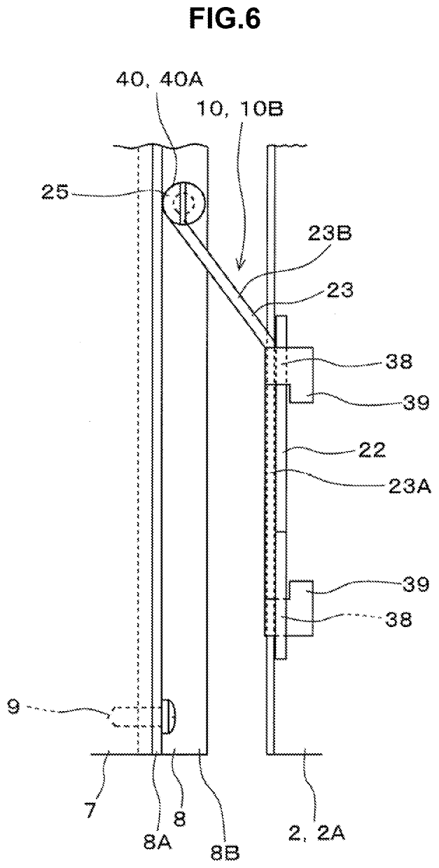

FIG. 3 shows a state in which after the work of arranging the door frame 2 inside the opening portion 4A of the wall 4 is performed, the door frame 2 is coupled to the reinforcing members 7 by couplers 10 via the auxiliary members 8. As the couplers 10 used to couple the door frame 2 to the reinforcing members 7 via the auxiliary members 8, a plurality of couplers are provided for each of the left and right side frame members 2A and 2B and the upper frame member 2C of the door frame 2. The couplers 10 include first couplers 10A and second couplers 10B. FIG. 4 and FIG. 5 that is a front view of FIG. 4 show the first coupler 10A, and FIG. 6 shows the second coupler 10B. As shown in FIG. 3, the first couplers 10A couple the left and right side frame members 2A and 2B of the door frame 2, via the auxiliary members 8, to the reinforcing members 7 attached to the core members 5A and 5B while facing the side frame members 2A and 2B in the left-right direction. Also, the first couplers 10A couple the upper frame member 2C of the door frame 2, via the auxiliary member 8, to the reinforcing member 7 attached to the core member 5C while facing the upper frame member 2C in the upward-downward direction. In addition, the second couplers 10B couple the left and right side frame members 2A and 2B of the door frame 2, via the auxiliary members 8, to the reinforcing members 7 attached to the core members 5A and 5B while facing the side frame members 2A and 2B in the left-right direction.

As shown in FIG. 3, a plurality of first couplers 10A are arranged in the upward-downward direction that is the longitudinal direction of the left and right side frame members 2A and 2B, and a plurality of first couplers 10A are arranged in the left-right direction that is the longitudinal direction of the upper frame member 2C as well. One second coupler 10B is arranged near the lower end portion of each of the left and right side frame members 2A and 2B. Note that the second couplers 10B may be omitted.

As shown in FIGS. 4 and 5, the first coupler 10A is formed by a foundation member 20 arranged on the door frame 2, and a coupling member 21 arranged to be overlaid on the plate-shaped foundation member 20 in the thickness direction of the foundation member 20. The coupling member 21 is formed by a base portion 21A overlaid on the foundation member 20, and two coupling portions 21B and 21C extending from the base portion 21A to the side of the auxiliary member 8 obliquely in directions opposite to each other. The distal end portions of the coupling portions 21B and 21C are joined to the plate-shaped projecting piece portion 8B of the auxiliary member 8 by joints 24 that are drill screws, as shown in FIG. 5. Also, as shown in FIG. 6, the second coupler 10B is also formed by a foundation member 22 arranged on the door frame 2, and a coupling member 23 arranged to be overlaid on the plate-shaped foundation member 22 in the thickness direction of the foundation member 22. The coupling member 23 is formed by a base portion 23A overlaid on the foundation member 22, and one coupling portion 23B obliquely extending from the base portion 23A to the side of the auxiliary member 8. The distal end portion of the coupling portion 23B is joined to the plate-shaped projecting piece portion 8B of the auxiliary member 8 by a joint 25 that is a drill screw.

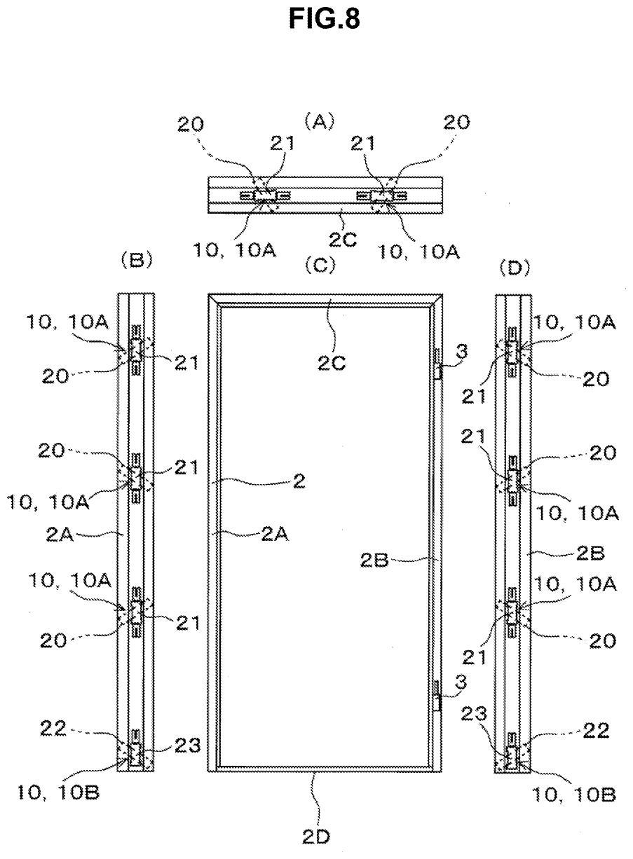

Note that the coupling portions 21B, 21C, and 23B of the coupling members 21 and 23 of the first and second couplers 10A and 10B are bent with respect to the base portions 21A and 23A and thus extend from the base portions 21A and 23A obliquely to the side of the auxiliary member 8. FIGS. 8(A) to 8(D) show a plan view, a right side view, a front view, and a left side view of the door frame 2 before the coupling portions 21B, 21C, and 23B are bent with respect to the base portions 21A and 23A. As is apparent from FIGS. 8(A) to 8(D), the foundation members 20 and 22 of the first and second couplers 10A and 10B arranged on the side frame members 2A and 2B and the upper frame member 2C of the door frame 2 are each made of a rectangular metal plate and have the same shape and same size.

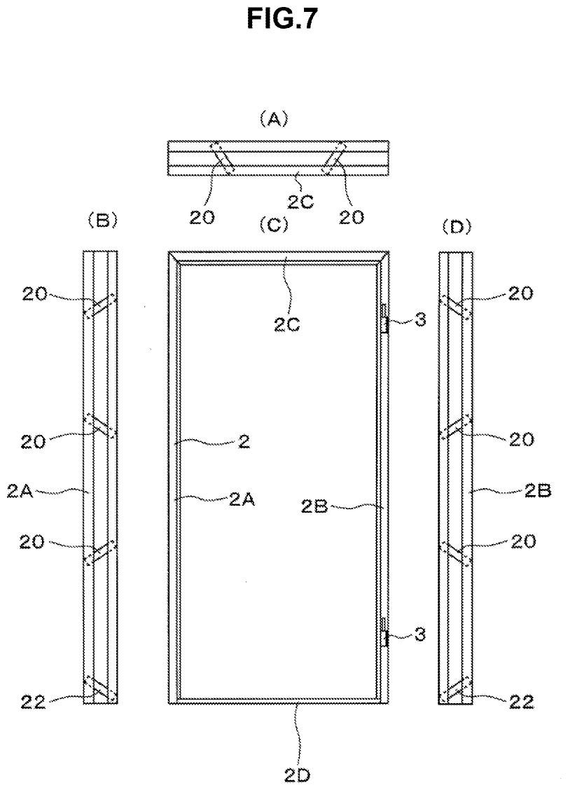

The foundation members 20 and 22 are fixed, by welding, to the left and right side frame members 2A and 2B and the upper frame member 2C that are constituent members of the door frame 2 in a factory where the door frame 2 is manufactured. That is, as shown in FIG. 7, a plurality of foundation members 20 and one foundation member 22 are fixed, by welding, to each of the side frame members 2A and 2B among the left and right side frame members 2A and 2B and the upper frame member 2C of the door frame 2 in the factory, and a plurality of foundation members 20 are fixed, by welding, to the upper frame member 2C in the factory.

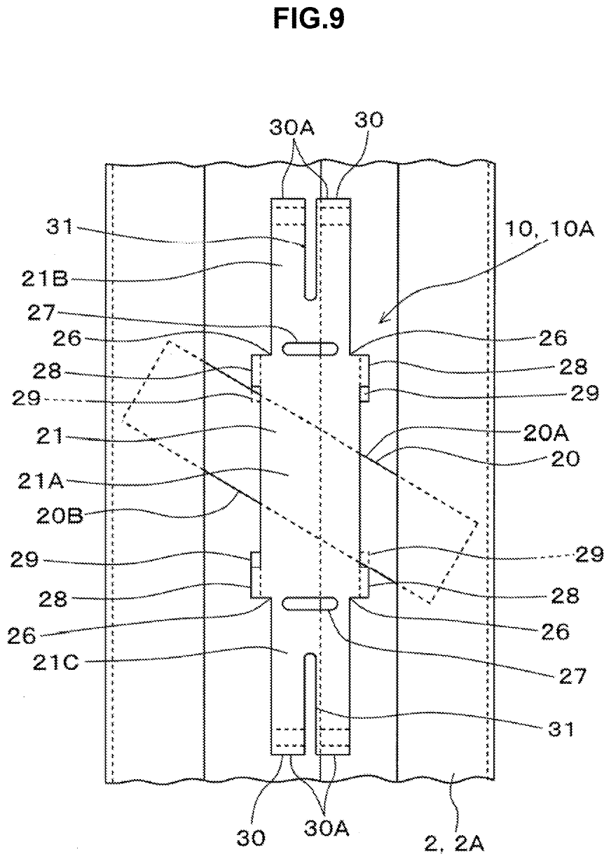

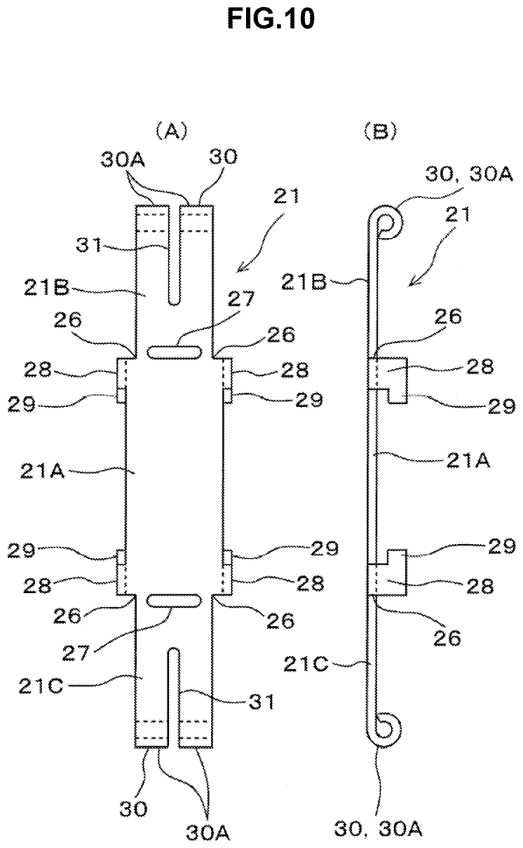

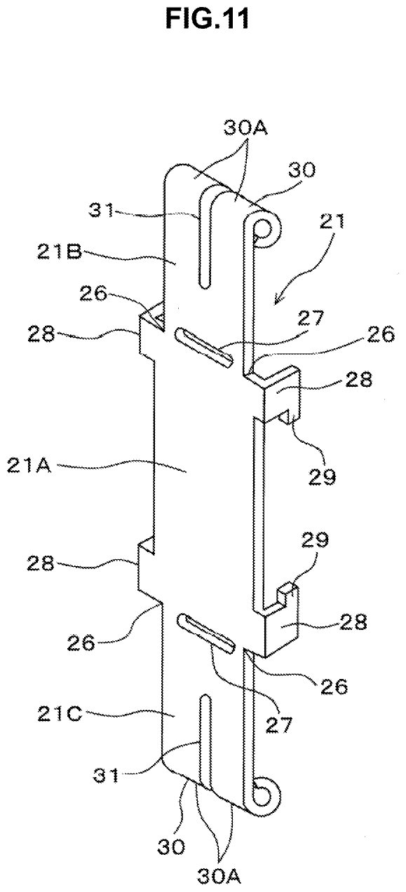

As is apparent from FIGS. 7(A) to 7(D) that are a plan view, a right side view, a front view, and a left side view of the door frame 2, a work of fixing the plurality of foundation members 20 and one foundation member 22 to each of the side frame members 2A and 2B by welding is performed by tilting the foundation members 20 and 22 in a direction orthogonal to the direction of the intervals between the side frame members 2A and 2B and the auxiliary members 8 on the sides of the core members 5A and 5B of the wall 4 and the thickness direction of the door frame 2, that is, the upward-downward direction that is the longitudinal direction of the side frame members 2A and 2B and sequentially reversing the tilting direction of the foundation members 20 and 22 with respect to the upward-downward direction, and setting the absolute tilting angles of the foundation members 20 and 22 (the tilting angle of the foundation members 20 and 22, except the vertical tilting directions) to the same angle. Also, a work of fixing the plurality of foundation members 20 to the upper frame member 2C by welding is performed by tilting the foundation members 20 in a direction orthogonal to the direction of the interval between the upper frame member 2C and the auxiliary member 8 on the side of the core member 5C of the wall 4 and the thickness direction of the door frame 2, that is, the left-right direction that is the longitudinal direction of the upper frame member 2C and sequentially reversing the tilting direction of the foundation members 20 with respect to the left-right direction, and setting the absolute tilting angles of the foundation members 20 (the tilting angle of the foundation members 20 and 22, except the horizontal tilting directions) to the same angle. FIG. 9 shows, in an enlarged state, the portion of the first coupler 10A among the first couplers 10A and the second couplers 10B shown in FIG. 8, and FIGS. 10 and 11 show only the coupling member 21 among the foundation member 20 and the coupling member 21, which are the constituent members of the first coupler 10A. FIGS. 10(A) and 10(B) are a side view and a front view of the coupling member 21, respectively, and FIG. 11 is a perspective view of the coupling member 21. As can be seen from FIGS. 10 and 11, the coupling member 21 is manufactured by performing punching, bending, and curling for a metal plate, and the two coupling portions 21B and 21C extend from the above-described base portion 21A in opposite directions. The left-right direction in FIG. 10(A) is the widthwise direction of the coupling member 21, and the widthwise direction is the thickness direction of the above-described door frame 2.

The two coupling portions 21B and 21C of the coupling member 21 have the same width and the same extending length from the base portion 21A. In addition, the width of the two coupling portions 21B and 21C is smaller than the width of the base portion 21A that is the main body of the coupling member 21. For this reason, step portions 26 in the widthwise direction are formed due to the width difference at the boundary portions between the base portion 21A and the two coupling portions 21B and 21C. Also, long holes 27 that are long in the widthwise direction are formed in the base portions of the coupling portions 21B and 21C on the sides of the base portion 21A in the vicinity of these boundary portions. The long holes 27 are through holes extending through the coupling member 21 in the thickness direction.

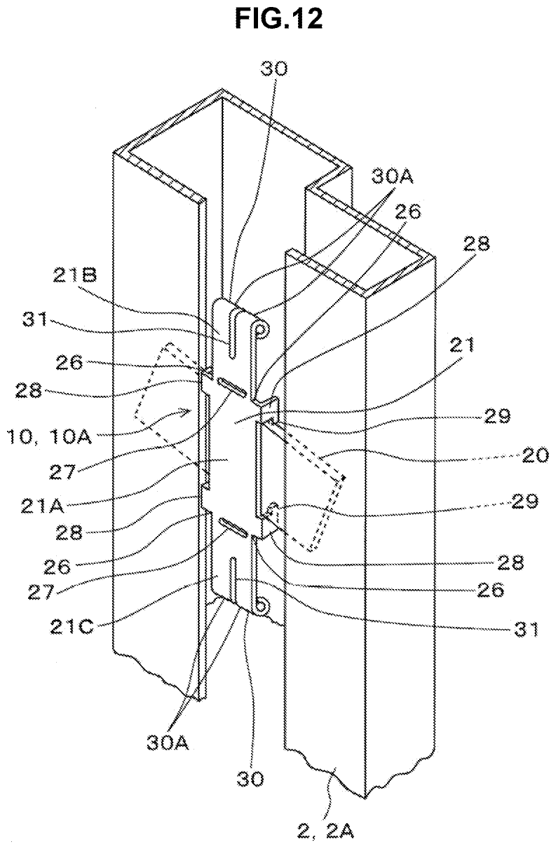

Furthermore, at the end portions of the side portions of the base portion 21A on both sides in the widthwise direction on the sides of the two coupling portions 21B and 21C, four straddling portions 28 projecting in a direction orthogonal to the widthwise direction of the coupling member 21 and the extending directions of the coupling portions 21B and 21C, that is, in the thickness direction of the coupling member 21 are formed to be connected to the base portion 21A. When the base portion 21A of the coupling member 21 is arranged to be overlaid on the foundation member 20, the straddling portions 28 straddle the outer sides of the foundation member 20 that is a plate-shaped member, as shown in FIG. 12. A detachment preventing portion 29 is formed at the distal end portion of each straddling portion 28, that is an end portion on the opposite side of the base portion 21A. Among the detachment preventing portions 29, two detachment preventing portions 29 separately provided on each of the sides of the two coupling portions 21B and 21C project from the straddling portions 28 toward the inside of the base portion 21A such that these project in opposite sides. Hence, the detachment preventing portions 29 project in directions to face each other.

Concerning the coupling member 21 whose base portion 21A is overlaid, in the thickness direction of the foundation member 20, on the foundation member 20 arranged on each of the side frame members 2A and 2B of the door frame 2, the direction in which the detachment preventing portions 29 project is the upward-downward direction that is the direction orthogonal to the direction of the intervals between the side frame members 2A and 2B and the auxiliary members 8 on the sides of the core members 5A and 5B of the wall 4 and the thickness direction of the door frame 2. Concerning the coupling member 21 whose base portion 21A is overlaid, in the thickness direction of the foundation member 20, on the foundation member 20 arranged on the upper frame member 2C, the direction in which the detachment preventing portions 29 project is the left-right direction that is the direction orthogonal to the direction of the interval between the upper frame member 2C and the auxiliary member 8 on the side of the core member 5C of the wall 4 and the thickness direction of the door frame 2.

Thus, when the base portion 21A of the coupling member 21 is arranged to be overlaid on the foundation member 20 of the first coupler 10A stationarily arranged on each of the side frame members 2A and 2B and the upper frame member 2C of the door frame 2, two detachment preventing portions 29 arranged in the diagonal direction of the base portion 21A among the detachment preventing portions 29 face the foundation member 20 on the back side of the foundation member 20 as the straddling portions 28 with the detachment preventing portions 29 provided at the distal ends straddle the outer sides of the foundation member 20.

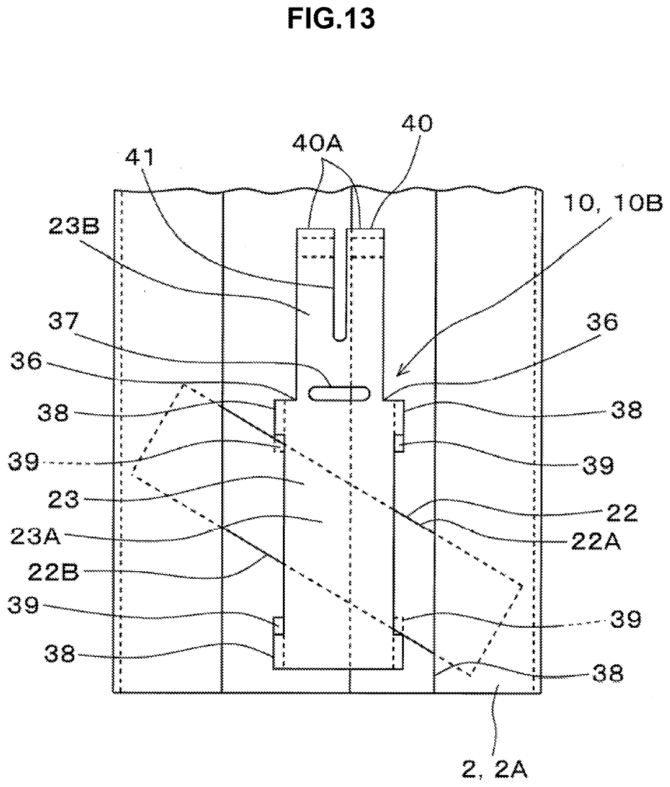

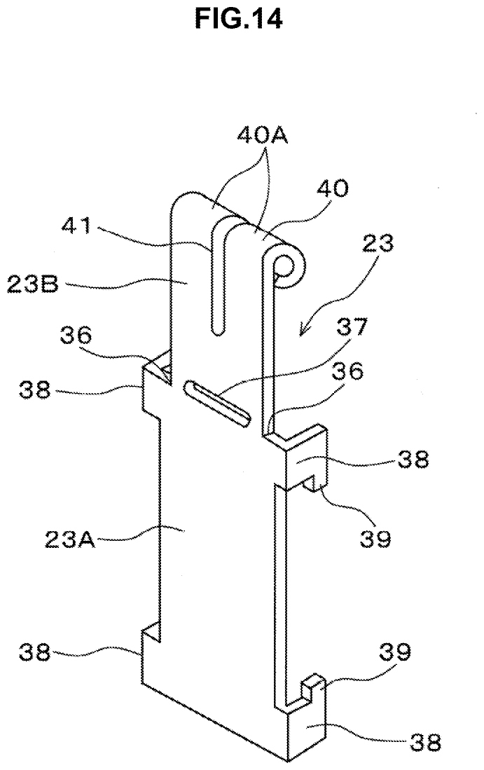

As shown in FIG. 10(A), tubular portions 30 formed by curling the coupling portions 21B and 21C having a plate shape are provided at the distal end portions of the two coupling portions 21B and 21C. Also, in each of the coupling portions 21B and 21C, a cut portion 31 cut from the distal end side of each of the coupling portions 21B and 21C to the side of the base portion 21A is formed at the center portion of each of the coupling portions 21B and 21C in the widthwise direction. By the cut portion 31, each tubular portion 30 is divided into two divided tubular portions 30A. FIG. 13 shows, in an enlarged state, the portion of the second coupler 10B among the first couplers 10A and the second couplers 10B shown in FIG. 8, and FIG. 14 is a perspective view showing only the coupling member 23 among the foundation member 22 and the coupling member 23, which are the constituent members of the second coupler 10B. As can be seen from FIG. 14, the coupling member 23 is manufactured by performing punching, bending, and curling for a metal plate, and the one coupling portion 23B extends from the above-described base portion 23A. The widthwise direction of the coupling member 23 is the same direction as the widthwise direction of the coupling member 21 of the first coupler 10A, and the widthwise direction is the thickness direction of the door frame 2.

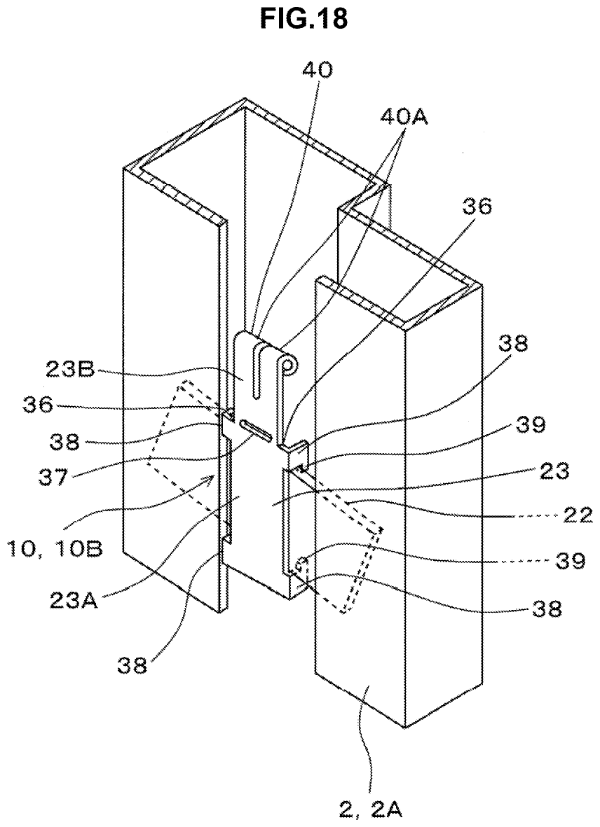

The coupling member 23 of the second coupler 10B is the same as a structure obtained by omitting one coupling portion 21C of the two coupling portions 21B and 21C provided in the coupling member 21 of the first coupler 10A. For this reason, the base portion 23A and the coupling portion 23B of the coupling member 23 correspond to the base portion 21A and the coupling portion 21B of the coupling member 21. Since the width of the coupling portion 23B is smaller than the width of the base portion 23A that is the main body of the coupling member 23, step portions 36 in the widthwise direction are formed due to the width difference at the boundary portion between the base portion 23A and the coupling portion 23B. A long hole 37 that extends through the coupling member 23 in the thickness direction and is long in the widthwise direction of the coupling member 23 is formed in the base portion of the coupling portion 23B on the side of the base portion 23A in the vicinity of these boundary portion. In addition, at the end portions of the side portions of the base portion 23A on both sides in the widthwise direction on the side of the coupling portion 23B and at the end portions on the opposite side of the end portions, four straddling portions 38 connected to the base portion 23A are formed to project in a direction orthogonal to the widthwise direction of the coupling member 23 and the extending direction of the coupling portion 23B, that is, in the thickness direction of the coupling member 23. When the base portion 23A of the coupling member 23 is arranged to be overlaid on the foundation member 22 of the second coupler 10B stationarily arranged on each of the side frame members 2A and 2B of the door frame 2, as shown in FIG. 18, the straddling portions 38 straddle the outer sides of the foundation member 22 that is a plate-shaped member.

A detachment preventing portion 39 is formed at the distal end portion of each straddling portion 38, that is an end portion on the opposite side of the base portion 23A. Among the detachment preventing portions 39, two detachment preventing portions 39 separately provided at each of the end portion on the side of the coupling portion 23B and the end portion on the opposite side of the end portion project from the straddling portions 38 toward the inside of the base portion 23A such that these project in opposite sides. The detachment preventing portions 39 project in directions to face each other. Thus, when the coupling member 23 is arranged by overlaying the base portion 23A of the coupling member 23 on the foundation member 22 stationarily arranged on each of the side frame members 2A and 2B of the door frame 2, two detachment preventing portions 39 arranged in the diagonal direction of the base portion 23A among the detachment preventing portions 39 face the foundation member 22 on the back side of the foundation member 22 as the straddling portions 38 with the detachment preventing portions 39 provided at the distal ends straddle the outer sides of the foundation member 22.

Also, as shown in FIG. 14, a tubular portion 40 formed by curling the coupling portions 21B and 21C having a plate shape is provided at the distal end portion of the coupling portion 23B. In the coupling portion 23B, a cut portion 41 cut from the distal end side of the coupling portion 23B to the side of the base portion 23A is formed at the center portion of the coupling portion 23B in the widthwise direction. Hence, by the cut portion 41, the tubular portion 40 is divided into two divided tubular portions 40A.

As described above, a work of causing two detachment preventing portions 29 arranged in the diagonal direction of the base portion 21A among the four detachment preventing portions 29 provided on the coupling member 21 of the first coupler 10A to face the foundation member 20 on the back side of the foundation member 20 stationarily arranged on each of the side frame members 2A and 2B and the upper frame member 2C of the door frame 2 and overlaying the base portion 21A of the coupling member 21 on the foundation member 20 in the thickness direction of the foundation member 20 and a work of causing two detachment preventing portions 39 arranged in the diagonal direction of the base portion 23A among the four detachment preventing portions 39 provided on the coupling member 23 of the second coupler 10B to face the foundation member 22 on the back side of the foundation member 22 stationarily arranged on each of the side frame members 2A and 2B of the door frame 2 and overlaying the base portion 23A of the coupling member 23 on the foundation member 22 in the thickness direction of the foundation member 22 are executed after the door frame 2 is carried from the factory into the installation/construction site of the opening device shown in FIG. 1. These works are performed by setting the postures of the coupling members 21 and 23 of the first and second couplers 10A and 10B to postures making a right angle with respect to the foundation members 20 and 22 tilting with respect to the side frame members 2A and 2B and the upper frame member 2C of the door frame 2 and after that, changing the postures of the coupling members 21 and 23 to postures parallel to the longitudinal direction of the side frame members 2A and 2B or the upper frame member 2C of the door frame 2.

Note that the above-described works may be executed before the door frame 2 is carried from the factory into the installation/construction site of the opening device shown in FIG. 1 by making the projection amounts of the detachment preventing portions 29 and 39 from the straddling portions 28 and 38 sufficiently large, and before the foundation members 20 and 22 are stationarily arranged on the side frame members 2A and 2B and the upper frame member 2C of the door frame 2 in the factory, inserting the foundation members 20 and 22 between the detachment preventing portions 29 and 39 and the base portions 21A and 23A of the coupling members 21 and 23 from the horizontal direction such that the detachment preventing portions 29 and 39 prevent the coupling members 21 and 23 from dropping out of the foundation members 20 and 22.

After the first and second couplers 10A and 10B are arranged on the door frame 2 by the above-described works, a work of inserting the door frame 2 into the opening portion 4A of the wall 4 described with reference to FIG. 2 is performed before the face materials 6 of the wall 4 shown in FIG. 4 are fixed on the core members 5. When performing this work, the coupling portions 21B, 21C, and 23B of the coupling members 21 and 23 of the first and second couplers 10A and 10B are not bent yet and are therefore flat with respect to the base portions 21A and 23A and extend from the base portions 21A and 23A in the longitudinal direction of the side frame members 2A and 2B and the upper frame member 2C. For this reason, even if the gap in the left-right direction between each of the side frame members 2A and 2B of the door frame 2 and a corresponding one of the auxiliary members 8 on the side of the core members 5A and 5B of the wall 4, which are two building materials connected by the first and second couplers 10A and 10B is small, and the gap in the upward-downward direction between the upper frame member 2C and the auxiliary member 8 on the side of the core member 5C of the wall 4 is small, the door frame 2 can easily be inserted into the opening portion 4A of the wall 4.

After that, a work of moving the coupling members 21 and 23 of the first and second couplers 10A and 10B in the thickness direction of the door frame 2 using the foundation members 20 and 21 as guide members to adjust the arrangement positions of the coupling members 21 and 23 in the foundation members 20 and 22 is performed. This adjustment work is a positioning work for setting the arrangement position of the door frame 2 in the thickness direction of the wall 4 to a predetermined position such that, for example, the center of the door frame 2 in the thickness direction and the center of the wall 4 in the thickness direction match when the side frame members 2A and 2B and the auxiliary members 8 on the sides of the core members 5A and 5B of the wall 4 are coupled by the first and second couplers 10A and 10B, and the upper frame member 2C and the auxiliary member 8 on the side of the core member 5C of the wall 4 are coupled by the first couplers 10A.

As for moving the coupling members 21 and 23 of the first and second couplers 10A and 10B in the thickness direction of the door frame 2 using the foundation members 20 and 22 as guide members, as shown in FIGS. 9 and 13, since the foundation members 20 and 22 are each formed by a rectangular plate material long in the horizontal direction, as for the foundation members 20 and 22 arranged in the side frame members 2A and 2B of the door frame 2, the movement is performed using outer edge portions 20A, 20B, 22A, and 22B, which are apart in the longitudinal direction of the side frame members 2A and 2B and are parallel to each other, as guide portions, and as for the foundation members 20 arranged in the upper frame member 2C, the movement is performed using the outer edge portions 20A and 20B, which are apart in the longitudinal direction of the upper frame member 2C and are parallel to each other, as guide portions. At this time, since, of the four detachment preventing portions 29 or 39 provided at the end portions of the straddling portions 28 or 38 connected to the base portion 21A or 23A that is the main body of the coupling member 21 or 23, the two detachment preventing portions 29 or 39 provided in the diagonal direction of the base portion 21A or 23A face the back side of the foundation member 20 or 22, the coupling members 21 and 23 can be prevented from being detached from the outer edge portions 20A, 20B, 22A, and 22B inserted between the detachment preventing portions 29 and 39 and the base portions 21A and 23A.

Also, since the foundation members 20 and 22 each have a flat plate shape as a whole, the guide portions by the outer edge portions 20A, 20B, 22A, and 22B are formed at the flat plate shaped portions of the foundation members 20 and 22 where the thickness is constant in the directions of moving the coupling members 21 and 23. For this reason, the movement of the coupling members 21 and 23, which is guided by the guide portions, can smoothly be performed.

More specifically, since the foundation members 20 and 22 of the first and second couplers 10A and 10B stationarily arranged on the side frame members 2A and 2B of the door frame 2 are tilted the upward-downward direction that is the direction orthogonal to the direction of the intervals between the side frame members 2A and 2B and the auxiliary members 8 on the sides of the core members 5A and 5B of the wall 4 and the thickness direction of the door frame 2, the guide portions by the outer edge portions 20A, 20B, 22A, and 22B of the foundation members 20 and 22, which are parallel to each other, each have a component in the thickness direction of the door frame 2 and a component in the upward-downward direction orthogonal to the thickness direction. Also, since the foundation members 20 of the first couplers 10A stationarily arranged on the upper frame member 2C of the door frame 2 are tilted in the left-right direction that is the direction orthogonal to the direction of the interval between the upper frame member 2C and the auxiliary member 8 on the side of the core member 5C of the wall 4 and the thickness direction of the door frame 2, the guide portions by the outer edge portions 20A and 20B of the foundation members, which are parallel to each other, each have a component in the thickness direction of the door frame 2 and a component in the left-right direction orthogonal to the thickness direction.

For this reason, as described above, if the coupling members 21 and 23 of the first and second couplers 10A and 10B are moved in the thickness direction of the door frame 2 using the foundation members 20 and 22 as guide members, among the coupling members 21 and 23, the coupling members 21 and 23 guided by the guide portions of the foundation members 20 and 22 arranged on the side frame members 2A and 2B of the door frame 2 move in the direction having the component in the thickness direction of the door frame 2 and the component in the upward-downward direction, and the coupling members 21 guided by the guide portions of the foundation members 20 arranged on the upper frame member 2C move in the direction having the component in the thickness direction of the door frame 2 and the component in the upward-downward direction.

After the work of adjusting the arrangement positions of the coupling members 21 and 23 of the foundation members 20 and 22 is executed in this way, a work of moving the arrangement position of the door frame 2 in the opening portion 4A of the wall 4 in the left-right direction that is the direction of the intervals between the side frame members 2A and 2B and the auxiliary members 8 on the sides of the core members 5A and 5B of the wall 4 shown in FIG. 3 and thus setting the arrangement position of the door frame 2 to an appropriate position in the left-right direction is performed.

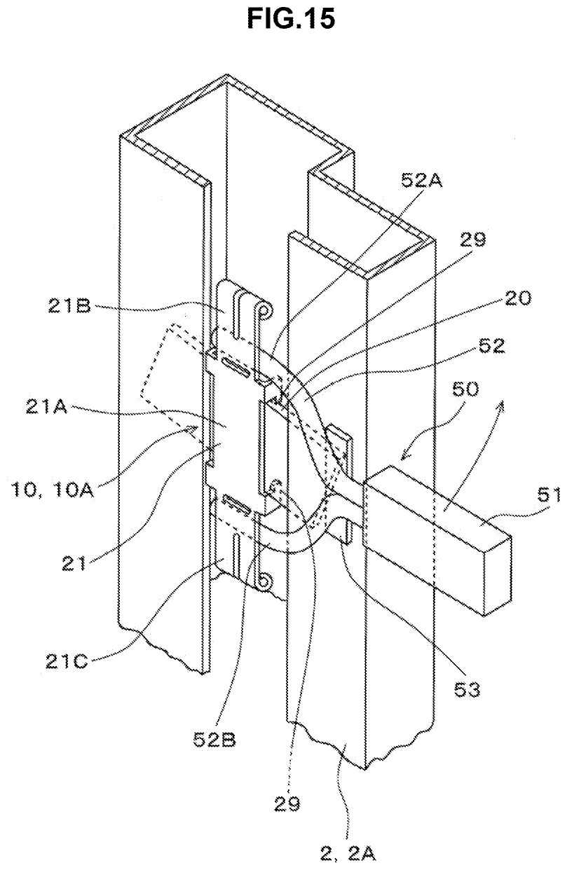

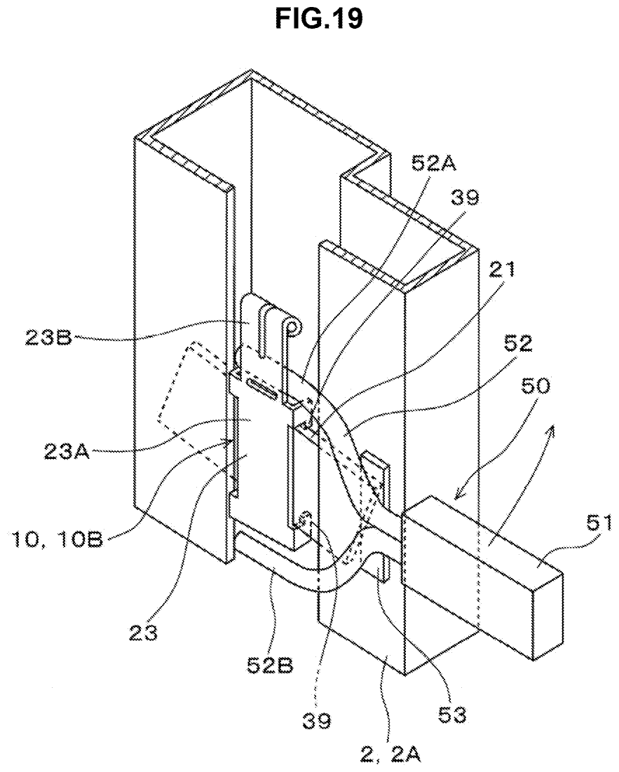

Next, works for bending the coupling portions 21B, 21C, and 23B of the coupling members 21 and 23 of the first and second couplers 10A and 10B with respect to the base portions 21A and 23A are performed. FIG. 15 shows, of these works, a bending work for the first coupler 10A arranged on the side frame member 2A of the door frame 2 as a representative example. FIG. 19 shows, of the works for bending the coupling portion 23B of the coupling member 23 in the second coupler 10B with respect to the base portion 23A, a bending work for the second coupler 10B arranged on the side frame member 2A of the door frame 2 as a representative example.

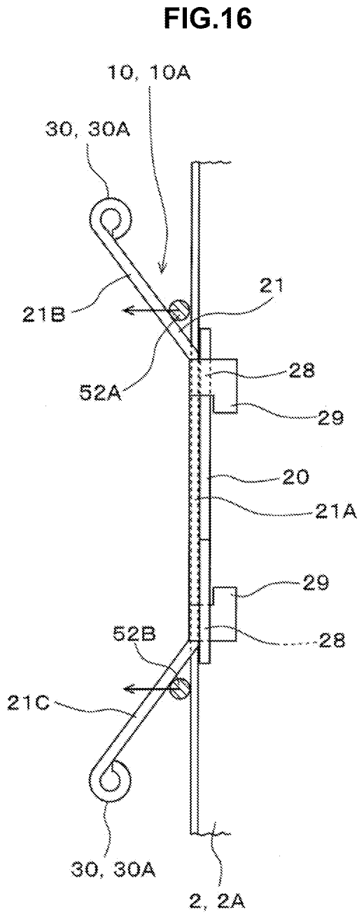

The work for bending the two coupling portions 21B and 21C of the coupling member 21 of the first coupler 10A with respect to the base portion 21A is performed using an operation tool 50 shown in FIG. 15. The operation tool 50 includes a grip portion 51 to be gripped by a hand of an operator, a forked portion 52 including two branch portions 52A and 52B branched and extended from the grip portion 51, and a cushion member 53 attached to the base portion of the forked portion 52. The branch portions 52A and 52B are inserted to the back side of the two coupling portions 21B and 21C of the coupling member 21, respectively, and the cushion member 53 is brought into contact with the outer surface of the door frame 2. After that, when the operator causes the grip portion 51 to pivot in the direction of an arrow using the point of the cushion member 53 as a fulcrum, the coupling portions 21B and 21C can be bent with respect to the base portion 21A, as shown in FIG. 16, and the coupling portions 21B and 21C can thus be made to obliquely face the side of the wall 4.

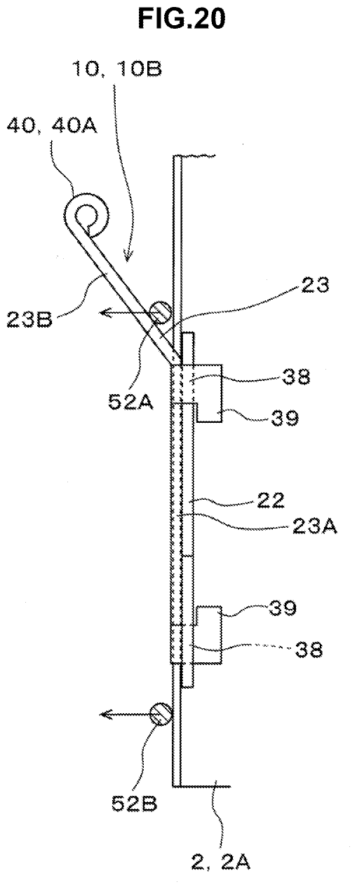

In addition, the work for bending the coupling portion 23B of the coupling member 23 in the second coupler 10B shown in FIG. 19 is also performed using the operation tool 50. The bending work is performed by inserting one branch portion 52A of the two branch portions 52A and 52B to the back side of the coupling member 23, bringing the cushion member 53 into contact with the outer surface of the door frame 2, like the first coupler 10A, and, after that, causing, by the operator, the grip portion 51 to pivot in the direction of an arrow using the point of the cushion member 53 as a fulcrum. Thus, the coupling portion 23B can be bent with respect to the base portion 23A, as shown in FIG. 20, and the coupling portion 23B can be made to obliquely face the side of the wall 4.

Note that the reason why the coupling portion of the coupling member 23 of the second coupler 10B includes only one coupling portion 23B, unlike the two coupling portions 21B and 21C of the coupling member 21 of the first coupler 10A, is that the second coupler 10B is arranged near the lower end portion of each of the side frame members 2A and 2B of the door frame 2, as described above, and therefore, this arrangement should be performed without interference with a floor where the hinged door device is arranged.

When the coupling portions 21B, 21C, and 23B of the coupling members 21 and 23 of the first and second couplers 10A and 10B are bent with respect to the base portions 21A and 23A in the above-described way, as is apparent from FIG. 4 that shows the coupling portion 21B of the coupling member 21 of the first coupler 10A arranged on the side frame member 2A, the two coupling portions 21B and 21C provided on the coupling member 21 of the first coupler 10A and the coupling portion 23B provided on the coupling member 23 of the second coupler 10B approach the auxiliary member 8 attached to the above-described reinforcing member 7 of the wall 4. Furthermore, if bending is performed, the plate-shaped projecting piece portion 8B of the auxiliary member 8, which projects to the side of the door frame 2, can be inserted into the cut portions 31 and 41 formed in the coupling portions 21B, 21C, and 23B.

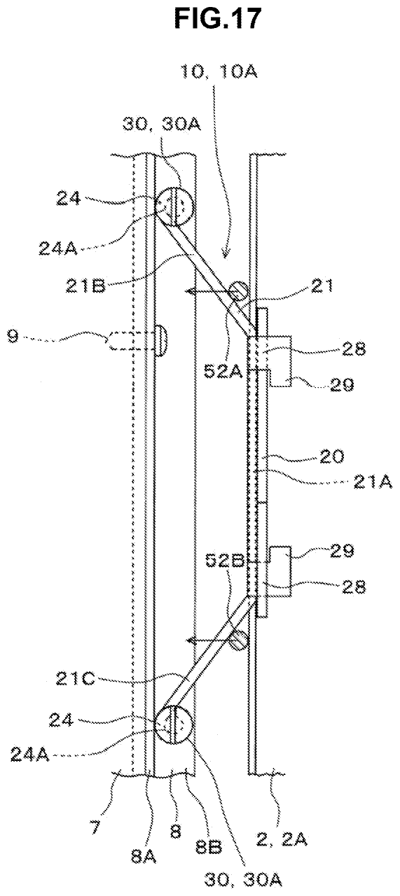

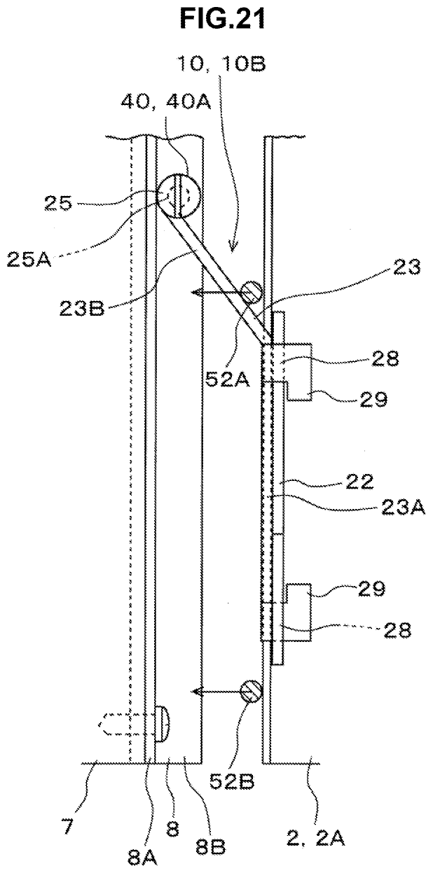

After that, as shown in FIGS. 17 and 21, when shaft portions 24A and 25A of the above-described joints 24 and 25 that are drill screws are inserted into the tubular portions 30 and 40 formed at the distal end portions of the coupling portions 21B, 21C, and 23B, and the joints 24 and 25 are rotated by a power tool or the like, the distal end portions of the coupling portions 21B, 21C, and 23B are joined to the auxiliary member 8 by the joints 24 and 25 while performing threading hole machining for the plate-shaped projecting piece portion 8B of the auxiliary member 8 by the distal ends of the shaft portions 24A and 25A. Hence, the door frame 2 is coupled to the reinforcing members 7 provided in the wall 4 while facing the side frame members 2A and 2B and the upper frame member 2C of the door frame 2 via the auxiliary members 8 by the first and second couplers 10A and 10B.

Note that when joining the distal end portions of the coupling portions 21B, 21C, and 23B to the auxiliary member 8 by the joints 24 and 25 while performing threading hole machining for the plate-shaped projecting piece portion 8B of the auxiliary member 8 by the distal ends of the shaft portions 24A and 25A of the joints 24 and 25, as shown in FIGS. 17 and 21, the distal end portions of the coupling portions 21B, 21C, and 23B are preferably pressed against the surface of the projecting piece portion 8A by continuously pressing the coupling portions 21B, 21C, and 23B by the branch portions 52A and 52B of the operation tool 50. According to this, at the time of threading hole machining, it is possible to easily perform the threading hole machining by preventing the coupling portions 21B, 21C, and 23B from being finely moved by a vibration or the like.

According to the first and second couplers 10A and 10B of the above-described embodiment, the coupling portions 21B, 21C, and 23B of the coupling members 21 and 23 for coupling the door frame 2 and the auxiliary member 8 of the wall 4, which are two building materials, can be bent with respect to the base portions 21A and 23A of the coupling members 21 and 23, and when the bending is performed, the distal end portions of the coupling members 21 and 23 can be joined to the auxiliary member 8 by the joints 24 and 25. It is therefore possible to simplify the structures of the coupling members 21 and 23 and, in turn, simplify the overall structures of the first and second couplers 10A and 10B.

When, by the above-described work, the distal end portions of the coupling portions 21B, 21C, and 23B are joined to the auxiliary member 8 by the joints 24 and 25, in each of the first couplers 10A that couple the side frame members 2A and 2B of the door frame 2 and the auxiliary members 8 on the sides of the core members 5A and 5B of the wall 4, as shown in FIG. 17, one coupling portion 21B of the two coupling portions 21B and 21C provided on the coupling member 21 of the first coupler 10A is tilted upward and coupled to the auxiliary member 8 on the side of a corresponding one of the core members 5A and 5B of the wall 4, and the other coupling portion 21C is tilted downward and coupled to the auxiliary member 8 on the side of a corresponding one of the core members 5A and 5B of the wall 4. For this reason, the angles made by the coupling portions 21B and 21C with respect to the left-right direction that is the direction of the interval between the door frame 2 and the auxiliary members 8 on the sides of the core members 5A and 5B of the wall 4 are different, and the two coupling portions 21B and 21C make an angle. Hence, the door frame 2 can be made immobile, by the coupling portions 21B and 21C, in the upward-downward direction that is the direction orthogonal to the direction of the intervals between the side frame members 2A and 2B and the auxiliary members 8 on the sides of the core members 5A and 5B of the wall 4 and the thickness direction of the door frame 2.

Also, in each of the first couplers 10A that couple the upper frame member 2C of the door frame 2 and the auxiliary member 8 on the side of the core member 5C of the wall 4, although not illustrated, one coupling portion 21B of the two coupling portions 21B and 21C provided on the coupling member 21 of the first coupler 10A is tilted to one side in the left-right direction and coupled to the auxiliary member 8 on the side of the core member 5C of the wall 4, and the other coupling portion 21C is tilted to the other side in the left-right direction and coupled to the auxiliary member 8 on the side of the core member 5C of the wall 4. For this reason, the angles made by the coupling portions 21B and 21C with respect to the upward-downward direction that is the direction of the interval between the door frame 2 and the auxiliary member 8 on the side of the core member 5C of the wall 4 are different, and the two coupling portions 21B and 21C make an angle. Hence, the door frame 2 can be made immobile, by the coupling portions 21B and 21C, in the left-right direction that is the direction orthogonal to the direction of the interval between the upper frame member 2C and the auxiliary member 8 on the side of the core member 5C of the wall 4 and the thickness direction of the door frame 2.

Furthermore, as described above, the foundation members 20 of the plurality of first couplers 10A arranged on the side frame members 2A and 2B are arranged on the side frame members 2A and 2B by tilting the foundation members 20 in the upward-downward direction that is the direction orthogonal to the direction of the intervals between the side frame members 2A and 2B and the auxiliary members 8 on the sides of the core members 5A and 5B of the wall 4 and the thickness direction of the door frame 2, sequentially reversing the tilting direction of the foundation members 20 with respect to the upward-downward direction, and setting the absolute tilting angles of the foundation members 20 to the same angle. Hence, the above-described guide portions formed by the outer edge portions 20A and 20B of the foundation members 20, which are parallel to each other, have the same tilting direction and the same tilting angle as the foundation members 20.

For this reason, guide portions whose tilting directions with respect to the upward-downward direction are different exist among the guide portions provided on the foundation members 20.

Also, the foundation members 20 of the plurality of first couplers 10A arranged on the upper frame member 2C are arranged on the upper frame member 2C by tilting the foundation members 20 in the left-right direction that is the direction orthogonal to the direction of the interval between the upper frame member 2C and the auxiliary member 8 on the side of the core member 5C of the wall 4 and the thickness direction of the door frame 2, reversing the tilting direction of the foundation members 20 with respect to the left-right direction, and setting the absolute tilting angles of the foundation members 20 to the same angle. Hence, the above-described guide portions formed by the outer edge portions 20A and 20B of the foundation members 20, which are parallel to each other, have the same tilting direction and the same tilting angle as the foundation members 20.

For this reason, guide portions whose tilting directions with respect to the left-right direction are different exist among the guide portions provided on the foundation members 20.

For this reason, after the distal end portions of each coupling member 21 are joined to the auxiliary member 8 by the joints 24 and 25, the door frame 2 coupled to the reinforcing members 7 of the wall 4 via the auxiliary members 8 by the first and second couplers 10A and 10B is set in an immobile state in which it cannot move in the thickness direction of the door frame 2 as it cannot move in the thickness direction of the door frame 2 with respect to the first and second couplers 10A and 10B. Hence, before the distal end portions of each coupling member 21 are joined to the auxiliary member 8 by the joints 24 and 25, this is executed by moving the coupling member 21 guided by the guide portions of the foundation member 20. For example, if the door frame 2 is arranged at a predetermined position in the thickness direction of the wall 4 by making the center of the door frame 2 in the thickness direction match the center of the wall 4 in the thickness direction, as described above, the door frame 2 can be set in a positioned state at the predetermined position in the thickness direction of the door frame 2 and coupled to the reinforcing member 7 of the wall 4 by the first and second couplers 10A and 10B via the auxiliary member 8.

Hence, according to this embodiment, coupling the door frame 2 and the auxiliary member 8 on the side of the wall 4, which are two building materials, by the plurality of first and second couplers 10A and 10B by positioning the door frame 2 in the thickness direction of the door frame 2 can be implemented by, arranging the foundation members 20 with different tilting angles when arranging the plurality of foundation members 20 on the side frame members 2A and 2B and the upper frame member 2C. It is therefore possible to simplify the structure of the first coupler 10A.

Note that in this embodiment, the work of positioning the door frame 2 in the thickness direction of the door frame 2 and setting it in the immobile state in which the door frame 2 cannot move after the distal end portions of the coupling member 21 of each first coupler 10A are joined to the auxiliary member 8 by the joints 24 and 25, as described above, is performed, concerning the plurality of foundation members 20 arranged on the side frame members 2A and 2B of the door frame 2, by tilting the foundation members 20 in the upward-downward direction that is the direction orthogonal to the direction of the intervals between the side frame members 2A and 2B and the auxiliary members 8 on the sides of the core members 5A and 5B of the wall 4 and the thickness direction of the door frame 2, sequentially reversing the tilting direction of the foundation members 20 with respect to the upward-downward direction, and setting the absolute tilting angles of the foundation members 20 to the same angle. Also, concerning the plurality of foundation members 20 arranged on the upper frame member 2C, the work is performed by tilting the foundation members 20 in the left-right direction that is the direction orthogonal to the direction of the interval between the upper frame member 2C and the auxiliary member 8 on the side of the core member 5C of the wall 4 and the thickness direction of the door frame 2, reversing the tilting direction of the foundation members 20 with respect to the left-right direction, and setting the absolute tilting angles of the foundation members 20 to the same angle. However, even if, for the plurality of foundation members 20 arranged on the side frame members 2A and 2B, the foundation members 20 are caused to have the same tilting direction with respect to the upward-downward direction and have different tilting angles, and for the plurality of foundation members 20 arranged on the upper frame member 2C, the foundation members 20 are caused to have the same tilting direction with respect to the left-right direction and have different tilting angles, the door frame 2 can be set in the immobile state in which it cannot move in the thickness direction of the door frame 2.

Also, setting the door frame 2 in the immobile state in which it cannot move in the thickness direction of the door frame 2 can be implemented, for the plurality of foundation members 20 arranged on the side frame members 2A and 2B, by not tilting some of the foundation members 20 in the upward-downward direction and tilting the remaining foundation members 20 in the upward-downward direction, and for the plurality of foundation members 20 arranged on the upper frame member 2C, by not tilting some of the foundation members 20 in the left-right direction and tilting the remaining foundation members 20 in the left-right direction. Also, according to this embodiment, since the foundation members 20 and 22 of the first and second couplers 10A and 10B have the same shape and same size, the first and second couplers 10A and 10B can be produced using the foundation members 20 and 22 with common structures.

In addition, even if the foundation members 20 of the plurality of first couplers 10A are arranged on the side frame members 2A and 2B and the upper frame member 2C by, for the side frame members 2A and 2B of the door frame 2, changing the direction and the tilting angle with respect to the upward-downward direction and for the upper frame member 2C, changing the direction and the tilting angle with respect to the left-right direction, each coupling member 21 includes the detachment preventing portions 29 on both sides of the coupling member 21 in the widthwise direction at the same positions in the longitudinal direction of the side frame members 2A and 2B for the coupling members 21 arranged on the side frame members 2A and 2B, and at the same positions in the longitudinal direction of the upper frame member 2C for the coupling members 21 arranged on the upper frame member 2C. For this reason, among the four detachment preventing portions 29, the two detachment preventing portions 29 arranged in the diagonal direction face the foundation member 20 on the back side of the foundation member 20, and therefore, the coupling members 21 with a common structure can be used for the foundation members 20.

Furthermore, the coupling member 23 of the second coupler 10B according to this embodiment is the same as a structure obtained by omitting one coupling portion 21C of the two coupling portions 21B and 21C provided in the coupling member 21 of the first coupler 10A. For this reason, the coupling member 23 can easily be produced by performing processing of removing the coupling portion 21C from the coupling member 21.

Connecting the distal end portions of the coupling portions 21B, 21C, and 23B of the coupling members 21 and 23 of the first and second couplers 10A and 10B to the auxiliary member 8 by the joints 24 and 25 is performed using the joints 24 and 25 that are drill screws to the plate-shaped projecting piece portion 8B of the auxiliary member 8. Hence, even if the work of moving the arrangement position of the door frame 2 in the opening portion 4A of the wall 4 in the left-right direction that is the direction of the intervals between the side frame members 2A and 2B and the auxiliary members 8 on the sides of the core members 5A and 5B of the wall 4 shown in FIG. 3 and thus setting the arrangement position of the door frame 2 to an appropriate position in the left-right direction is performed before the joint work, as described above, the angle made by the two coupling portions 21B and 21C of the coupling member 21 of the first coupler 10A or the angle made by the coupling portion 23B of the coupling member 23 of the second coupler 10B with respect to the auxiliary member 8 changes, and the distal end portions of the coupling portions 21B, 21C, and 23B can be joined as specified to the auxiliary member 8 by the joints 24 and 25.

If the arrangement position of the door frame 2 in the opening portion 4A of the wall 4 is changed in the upward-downward direction to set the arrangement position of the door frame 2 to an appropriate position in the upward-downward direction, the angle made by the two coupling portions 21B and 21C of the coupling member 21 of the first coupler 10A arranged on the upper frame member 2C changes, and the distal end portions of the coupling portions 21B and 21C can thus be joined as specified to the auxiliary member 8 attached to the core member 5C of the wall 4 facing the upper frame member 2C.

Furthermore, since the work of joining the distal end portions of the coupling portions 21B, 21C, and 23B to the auxiliary member 8 by the joints 24 and 25 is performed by inserting the shaft portions 24A and 25A of the joints 24 and 25 into the tubular portions 30 and 40 provided at the distal end portions of the coupling portions 21B, 21C, and 23B, as shown in FIGS. 17 and 21, threading hole machining for the plate-shaped projecting piece portion 8B of the auxiliary member 8 can be performed by the shaft portions 24A and 25A while causing the tubular portions 30 and 40 to guide the shaft portions 24A and 25A.

Also, the cut portions 31 and 41 each of which divides a corresponding one of the tubular portions 30 and 40 into the two divided tubular portions 30A or 40A are provided in the coupling portions 21B, 21C, and 23B, the projecting piece portion 8B of the auxiliary member 8 is inserted into the cut portions 31 and 41, and threading hole machining is performed for the projecting piece portion 8B by the shaft portions 24A and 25A of the joints 24 and 25. For this reason, both immediately before the threading hole machining of the projecting piece portion 8B is performed by the shaft portions 24A and 25A of the joints 24 and 25 and immediately after the threading hole machining is performed, the shaft portions 24A and 25A can be guided by the tubular portions 30 and 40.

Also, after the distal end portions of the coupling portions 21B, 21C, and 23B are joined to the projecting piece portion 8B of the auxiliary member 8 by the joints 24 and 25, the plate-shaped projecting piece portion 8B is sandwiched between the two divided tubular portions 30A or 40A. It is therefore possible to prevent the coupling members 21 and 23 provided with the coupling portions 21B, 21C, and 23B from moving in the longitudinal direction of the tubular portions 30 and 40, that is, in the thickness direction of the door frame 2.

Additionally, the tubular portions 30 and 40 are formed by curling the distal end portions of the plate-shaped coupling members 21 and 23. For this reason, the tubular portions 30 and 40 can easily be provided on the coupling members 21 and 23 as compared to a case where the tubular portions 30 and 40 are provided by joining tubular members to the distal end portions fop the coupling members 21 and 23 by welding or the like.

Also, since the whole structure of each of the coupling members 21 and 23 of the first and second couplers 10A and 10B according to this embodiment described above is formed by a metal plate, flat plate shaped portions where the bending direction of the coupling portions 21B, 21C, and 23B with respect to the base portions 21A and 23A is the thickness direction are formed at the boundary portions between the base portions 21A and 23A and the coupling portions 21B, 21C, and 23B or in the vicinity of the boundary portions. For this reason, the bending work of the coupling portions 21B, 21C, and 23B by the operation tool 50 can easily be executed.

At the boundary portions between the base portions 21A and 23A and the coupling portions 21B, 21C, and 23B, the step portions 26 and 36 are formed due to the difference between the width of the base portions 21A and 23A and the width of the coupling portions 21B, 21C, and 23A, as described above. Since the step portions 26 and 36 are strength decreasing portions that decrease the bending strength of the coupling portions 21B, 21C, and 23B with respect to the base portions 21A and 23A, the bending work of the coupling portions 21B, 21C, and 23A by the operation tool 50 can easily be executed even in this respect.

Furthermore, in the vicinity of the boundary portions of the base portions 21A and 23A and the coupling portions 21B, 21C, and 23B, the long holes 27 and 37 that are long in a direction corresponding to the thickness direction of the door frame 2 and the widthwise direction of the coupling members 21 and 23 are formed to extend through the coupling members 21 and 23 in the thickness direction, as described above. Since the long holes 27 and 37 also serve as strength decreasing portions that decrease the bending strength of the coupling portions 21B, 21C, and 23B with respect to the base portions 21A and 23A, the bending work of the coupling portions 21B, 21C, and 23A by the operation tool 50 can easily be executed even in this respect.

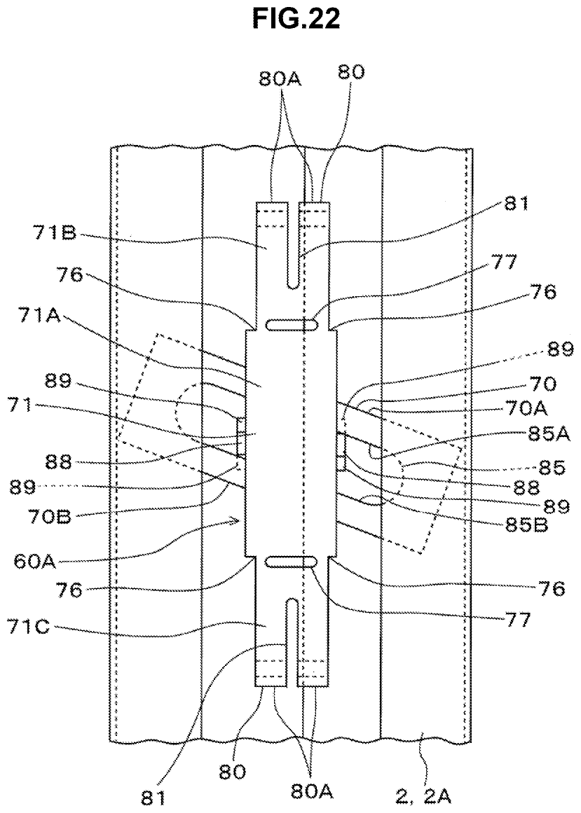

FIG. 22 shows a first coupler 60A according to another embodiment. The first coupler 60A is formed to include, as constituent members, a rectangular foundation member 70 made of a metal plate stationarily arranged on a door frame 2, and a coupling member 71 arranged to be overlaid on the foundation member 70 in the thickness direction of the foundation member 70. Like the first coupler 10A according to the above-described embodiment, the coupling member 71 is formed by a base portion 71A arranged to be overlaid on the foundation member 70 in the thickness direction of the foundation member 70, and two coupling portions 71B and 71C extending from the base portion 71A in directions opposite to each other. Also, in the coupling member 71, step portions 76 and long holes 77 serving as strength decreasing portions configured to decrease the bending strength of the coupling portions 71B and 71C with respect to the base portion 71A are formed. Also, a tubular portion 80 by two divided tubular portions 80A divided by a cut portion 81 is formed by curling at the distal end portion of each of the coupling portions 71B and 71C.

In the foundation member 70, a long hole 85 is formed in parallel to two outer edge portions 70A and 70B of the foundation member 70, which are parallel to each other, and in the long hole 85 having a component in the thickness direction of the door frame 2, two internal long side portions 85A and 85B that are parallel to each other serve as guide portions configured to guide movement of coupling member 71. In the foundation members 70 arranged on side frame members 2A and 2B of the door frame 2, the internal long side portions 85A and 85B are apart in the longitudinal direction of the side frame members 2A and 2B, and in the foundation members 70 arranged on an upper frame member 2C, these are apart in the longitudinal direction of the upper frame member 2C.

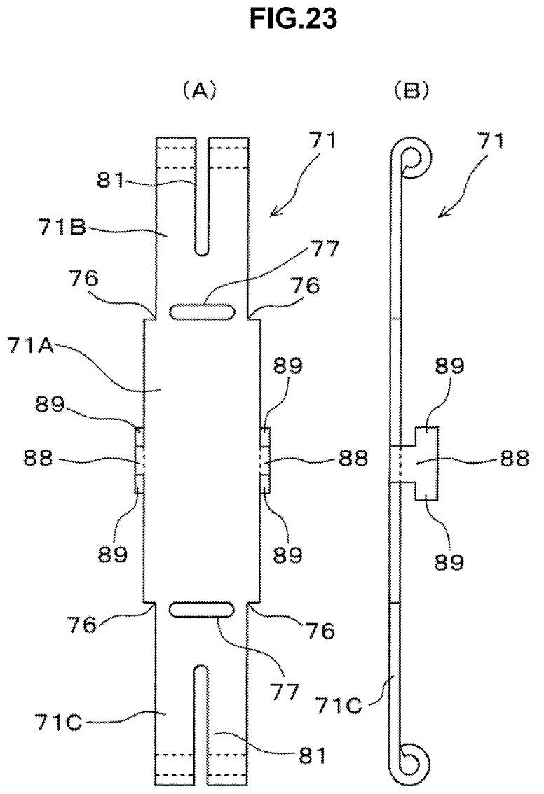

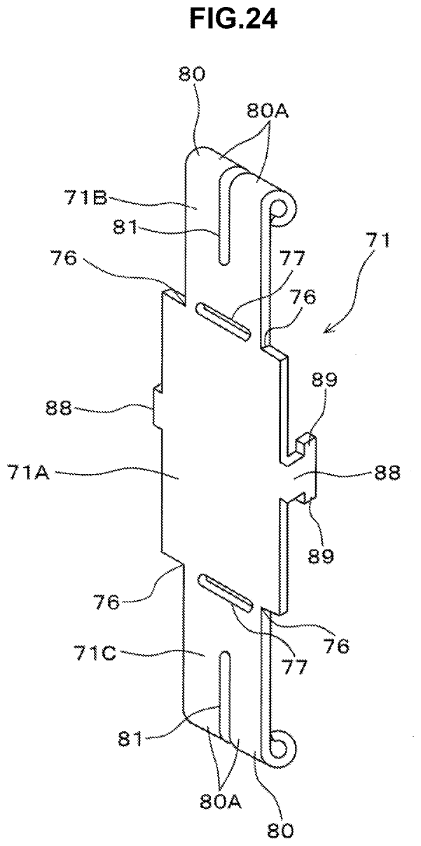

FIGS. 23(A) and 23(B) show a side view and a front view of the coupling member 71, respectively, and FIG. 24 shows a perspective view of the coupling member 71. As shown in FIGS. 23 and 24, on the base portion 71A of the coupling member 71, at the center between the two coupling portions 71B and 71C on both sides in the widthwise direction of the base portion 71A, two straddling portions 88 connected to the base portion 23A are formed to project in the thickness direction of the coupling member 71. As is apparent from FIG. 22, when the base portion 71A of the coupling member 71 is arranged to be overlayed on the foundation member 70 stationarily arranged on the side frame members 2A and 2B or the upper frame member 2C of the door frame 2, the straddling portions 88 straddle the two internal long side portions 85A and 85B of the long hole 85 formed in the foundation member 70 that is a plate-shaped member on the outer side of the internal long side portions 85A and 85B, that is, on the inner side of the long hole 85. At the distal end portion of each of the two straddling portions 88, two detachment preventing portions 89 are provided to project in directions opposite to each other.

For the coupling members 71 each having the base portion 71A overlaid on the foundation member 70 arranged on the side frame members 2A and 2B of the door frame 2 in the thickness direction of the foundation member 70, the projecting direction of the detachment preventing portions 89 is the upward-downward direction that is the direction orthogonal to the direction of the intervals between the side frame members 2A and 2B and auxiliary members 8 on the sides of core members 5A and 5B of a wall 4 and the thickness direction of the door frame 2, and for the coupling members 71 each having the base portion 71A overlaid on the foundation member 70 arranged on the upper frame member 2C in the thickness direction of the foundation member 70, the projecting direction is the left-right direction that is the direction orthogonal to the direction of the interval between the upper frame member 2C and the auxiliary member 8 on the side of a core member 5C of the wall 4 and the thickness direction of the door frame 2.

Like the foundation member 20 according to the above-described embodiment, each foundation member 70 arranged on the side frame members 2A and 2B of the door frame 2 is arranged to be tilted in the upward-downward direction that is the longitudinal direction of the side frame members 2A and 2B, and each foundation member 70 arranged on the upper frame member 2C is arranged to be tilted in the left-right direction that is the longitudinal direction of the upper frame member 2C. For this reason, the coupling member 71 can be guided by the guide portions of the foundation member 70 and moved while causing two detachment preventing portions 89 arranged in the diagonal direction among the four detachment preventing portions 89 provided on the coupling member 71 to face the foundation member 70 on the back side of the foundation member 70. The same effects as in the above-described embodiment can thus be obtained.

The coupler according to the above-described embodiment is the first coupler 60A with the two coupling portions 71B and 71C provided on the coupling member 71. Using the internal long side portions of the long hole as the guide portions that guide the movement of the coupling member can also be implemented even for a second coupler including one coupling portion on a coupling member.

### INDUSTRIAL APPLICABILITY

The present invention can be used for a work of coupling two building materials arranged at an interval.

### Explanation of the Reference Numerals and Signs

2 . . . door frame that is building material on opening device side
2A, 2B . . . side frame members
2C . . . upper frame member
7 . . . reinforcing member that is building material on wall side
8 . . . auxiliary member that is building material on wall side
10 . . . coupler
10A, 60A . . . first coupler
10B . . . second coupler
20, 70 . . . foundation member of first coupler
20A, 20B . . . outer edge portion that is guide portion
21, 71 . . . coupling member of first coupler
21A, 71A . . . base portion that is main body of coupling member of first coupler
21B, 21C, 71B, 71C . . . coupling portion of coupling member of first coupler
22 . . . foundation member of second coupler
22A, 22B . . . outer edge portion that is guide portion
23 . . . coupling member of second coupler
23A . . . base portion that is main body of coupling member of second coupler
23B . . . coupling portion of coupling member of second coupler
24, 25 . . . joint
24A, 25A . . . shaft portion of joint
26, 36, 76 . . . step portion serving as strength decreasing portion
27, 37, 77 . . . long hole serving as strength decreasing portion
28, 38, 88 . . . straddling portion
29, 39, 89 . . . detachment preventing portion
30, 40, 80 . . . tubular portion
30A, 40A, 80A . . . divided tubular portion
31, 41, 81 . . . cut portion
85 . . . long hole
85A, 85B . . . internal long side portion serving as guide portion

1. A building material coupling device for coupling two building materials arranged at an interval by a plurality of couplers,
each of the plurality of coupler including a foundation member arranged on one building material of the two building materials, and a coupling member having a length extending from the foundation member to a side of the other building material and joined to the other building material by a joint,
wherein the foundation member of each coupler is provided with a guide portion configured to guide the coupling member movably in a direction having a component in a thickness direction of the one building material, at least two couplers are provided on the one building material in a direction orthogonal to a direction of the interval and the thickness direction of the one building material, the guide portions of the foundation members of the couplers have different tilting directions or tilting angles with respect to the direction orthogonal to the direction of the interval and the thickness direction of the one building material, before the coupling member arranged for the foundation member of each coupler is joined to the other building material by the joint, each coupling member is guided by the guide portion to be movable, and since each coupling member is joined to the other building material by the joint, each coupling member cannot be guided by the guide portion and moved.

2. The building material coupling device according to claim 1, wherein the foundation members of the at least two couplers have the same shape and same size, and the foundation members are arranged on the one building material while the guide portions provided on the foundation members have different tilting directions or tilting angles with respect to the direction orthogonal to the direction of the interval and the thickness direction of the one building material.

3. The building material coupling device according to claim 1, wherein the foundation member is provided with an outer edge portion extending in a direction having a component in the thickness direction of the one building material, and the outer edge portion serves as the guide portion.

4. The building material coupling device according to claim 3, wherein the outer edge portion provided on the foundation member comprises two outer edge portions parallel to each other, and the outer edge portions serve as the guide portion.

5. The building material coupling device according to claim 1, wherein a long hole that is long in a direction having a component in the thickness direction of the one building material is formed in the foundation member, and an internal long side portion of the long hole serves as the guide portion.

6. The building material coupling device according to claim 5, wherein the long hole includes two internal long side portions parallel to each other, and the internal long side portions serve as the guide portion.

7. The building material coupling device according to claim 1, wherein the guide portion provided on the foundation member includes a flat plate-shaped portion whose thickness is constant in a direction in which the coupling member can move.

8. The building material coupling device according to claim 7, wherein the coupling member is provided with a detachment preventing portion that is connected to a main body of the coupling member and faces the foundation member on a back side of the foundation member, and the guide portion of the foundation member, which movably guides the coupling member, is inserted between the detachment preventing portion and the main body of the coupling member.

9. The building material coupling device according to claim 8, wherein the main body of the coupling member is provided with a straddling portion that straddles an outer side of the guide portion, and the detachment preventing portion projecting in the direction orthogonal to the direction of the interval and the thickness direction of the one building material is provided at an end portion of the straddling portion on an opposite side of the main body of the coupling member.

10. The building material coupling device according to claim 8, wherein a widthwise direction of the coupling member is the direction orthogonal to the direction of the interval and the thickness direction of the one building material, and the detachment preventing portions are provided on both sides of the coupling member in the widthwise direction, and the detachment preventing portions are provided at the same position in the direction orthogonal to the direction of the interval and the thickness direction of the one building material.

11. A building material coupling structure for coupling two building materials arranged at an interval by a plurality of couplers,
each of the plurality of couplers including a foundation member arranged on one building material of the two building materials, and a coupling member having a length extending from the foundation member to a side of the other building material and joined to the other building material by a joint,
wherein at least two couplers are provided on the one building material in a direction orthogonal to a direction of the interval and a thickness direction of the one building material, the foundation member of each coupler is provided with a guide portion configured to guide the coupling member movably in a direction having a component in the thickness direction of the one building material, the foundation members of the at least two couplers are arranged on the one building material while the guide portions of the foundation members of the at least two couplers have different tilting directions or tilting angles with respect to the direction orthogonal to the direction of the interval and the thickness direction of the one building material, before the coupling member arranged for each foundation member is joined to the other building material by the joint, each coupling member is guided by the guide portion to be movable, and since each coupling member is joined to the other building material by the joint, each coupling member cannot be guided by the guide portion and moved.

12. The building material coupling structure according to claim 11, wherein the foundation members of the at least two couplers have the same shape and same size, and the foundation members are arranged on the one building material while the guide portions provided on the foundation members have different tilting directions or tilting angles with respect to the direction orthogonal to the direction of the interval and the thickness direction of the one building material.

13. A building material coupling method for coupling two building materials arranged at an interval by a plurality of couplers,
each of the plurality of couplers including a foundation member arranged on one building material of the two building materials, and a coupling member having a length extending from the foundation member to a side of the other building material and joined to the other building material by a joint,
the method comprising:
a first work step of arranging the foundation members of at least two couplers on the one building material in a direction orthogonal to a direction of the interval and a thickness direction of the one building material, performing an arrangement work for the foundation members to the one building material while causing guide portions provided on the foundation members to guide the coupling members movably in a direction having a component in the thickness direction of the one building material to have different tilting directions or tilting angles with respect to the direction orthogonal to the direction of the interval and the thickness direction of the one building material, and causing the guide portion to guide and movably arrange the coupling member for each foundation member;
a second work step of adjusting an arrangement position of the coupling member on the foundation member in the direction having the component in the thickness direction of the one building material by causing the guide portion to guide and move each coupling member; and
a third work step of joining each coupling member to the other building material by the joint.

14. The building material coupling method according to claim 13,
wherein the foundation members of the at least two couplers have the same shape and same size, and in the first work step, the foundation members of the at least two couplers are arranged on the one building material while causing the guide portions provided on the foundation members to have different tilting directions or tilting angles with respect to the direction orthogonal to the direction of the interval and the thickness direction of the one building material.
